(19) United States
(12) Patent Application Publication
(10) Pub. No.: US 2007/0147299 A1
(43) Pub. Date: Jun. 28, 2007

(54) Wireless transmission device

(75) Inventors: Tatsuhiro Ando, Kawasaki (JP); Yoshihiro Kubota, Kawasaki (JP); Hidehiko Suzuki, Kawasaki (JP); Takuji Oyama, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/391,577

(22) Filed: Mar. 28, 2006

(30) Foreign Application Priority Data
Dec. 27, 2005 (JP) JP2005-375451

(51) Int. Cl. H04Q 7/00

(52) U.S. Cl. 370/331

(57) ABSTRACT

The wireless transmission device connected to any one of subnetworks configuring an IP network including a server managing IP addresses, and connecting a mobile terminal to any one of subnetworks, includes an address storage unit storing identifying information specifying the mobile terminal as a sender of a message and the IP address assigned to the mobile terminal from the server, a notifying unit notifying other wireless transmission devices of the stored information, and a proxy response unit responding, as a proxy for the server, when handover occurs, a message containing the IP address, as an assigned IP address, already assigned to the mobile terminal that is the sender of the received message based on the information stored in the address storage unit.

### BACKGROUND OF THE INVENTION

1. Field of the Invention

The present invention relates to a wireless transmission device in an IP mobile communication network.

2. Description of the Related Art

At the present, as in a wireless LAN (Local Area Network) using a wireless system defined by IEEE (Institute of Electrical and Electronic Engineers) 802.11 etc and in a communication system for providing an IP (Internet Protocol) telephone service etc, a mobile communication system configured by an IP network is actualized. The mobile communication system includes wireless transmission devices (access points) that connect IP mobile terminals to the mobile communication system by performing wireless communications.

The IP mobile terminal (which will hereinafter be referred to simply as a mobile terminal) is provided with a variety of communication services from the mobile communication system by performing the wireless communications with the wireless transmission device, corresponding to its existing location. The IP mobile terminal is exemplified such as a digital cellular phone, a PDA (Personal Digital Assistance) and a small-sized personal computer having a wireless communication function.

The conventional mobile communication system (which will hereinafter be simply termed the conventional system) configured by the IP network described above, will hereinafter be described with reference to FIG. 24. FIG. 24 is a diagram showing a network configuration of the conventional mobile communication system.

The conventional system in the example in FIG. 24 includes a DHCP (Dynamic Host Configuration Protocol) server 1001, a router 1002, layer-2 switches (which will hereinafter be simply termed an L2 switches) 1003 and 1004, and wireless transmission devices 1010, 1011 and 1012, and so on. These respective nodes have unique IP addresses and configure the IP network. Then, in the conventional system, the DHCP server 1001 automatically assigns the proper IP address to the mobile terminal 1100 connected to the self-system, thus connecting the mobile terminal 1100 to the self-system.

Further, in this conventional system, the IP network in the system is segmented into some subnetworks and is thus administered. According to the example in FIG. 24, the IP network is segmented into the a subnetwork 1 to which the wireless transmission devices 1010, 1011 and the L2 switch 1003 are connected, and into a subnetwork 2 to which the wireless transmission device 1012 and the L2 switch 1004 are connected. In such a case, it is general that each subnetwork is assigned a different network address. In the example in FIG. 24, a subnetwork 1 is assigned a network address [10.150.10.0], and a subnetwork 2 is assigned a network address [10.150.20.0]. IP packets forwarded to and from the subnetwork 1 and the subnetwork 2 are routed by the router 1002.

The mobile terminal 1100, in the case of desiring to connect to the conventional system, establishes a wireless link with the wireless transmission device 1011 having a wireless communicable range covering a self-positioned location, and thereafter receives the assigned IP address from the DHCP server 1001, corresponding to the subnetwork to which the wireless transmission device 1011 belongs. If the wireless transmission device 1011 belongs to the subnetwork 1, the mobile terminal 1100 is assigned an IP address, e.g., [10.150.10.50] corresponding to the subnetwork 1. Hereafter, the mobile terminal 1100 connects to this conventional system by use of the assigned IP address.

In this system environment, if the mobile terminal 1100 makes handover to the wireless transmission device across the subnetwork, it follows that a communication session of the mobile terminal 1100 is disconnected. For example, as shown in FIG. 24, this is a case wherein when the mobile terminal 1100 moves to a location B from a location A, the handover from the wireless transmission device 1011 to the wireless transmission device 1012 occurs.

In such a case, the mobile terminal 1100, as the handover destination wireless transmission device 1012 belongs to the subnetwork 2 different from the original wireless transmission device 1011, becomes unable to perform the communications with the conventional system by use of the pre-assigned IP address [10.150.10.50], and needs resetting the IP address corresponding to the subnetwork 2 to which the handover destination wireless transmission device 1012 belongs. In the case of requiring the resetting of the IP address, the mobile terminal 1100 is assigned a new IP address, e.g., [10.150.20.50] from the DHCP server, and it follows that a call remaining undisconnected is once disconnected at this time.

Such being the case, for preventing the disconnection of the communication session due to a change of the IP address, the mobile communication system requires a mechanism for keeping the communication session by retaining the same IP address when the handover takes place between the wireless transmission devices across the different subnetworks. Such a mechanism is exemplified by a proxy DHCP system. The mobile communication system employing the proxy DHCP system will hereinafter be described with reference to FIG. 25. FIG. 25 is a diagram showing the mobile communication system employing the proxy DHCP system. For giving an easy-to-understand explanation, the mobile communication system in FIG. 25 shall have the same network configuration in FIG. 24.

The system using the proxy DHCP system enables the communications via the handover destination wireless transmission device without changing the IP address by utilizing an IP (layer-3 (L3)) tunnel 1200 established between the handover source wireless transmission device and the handover destination wireless transmission device.

Namely, when the mobile terminal 1100 moves to the location B from the location A and when there occurs the handover from the wireless transmission device 1011 in the subnetwork 1 to the wireless transmission device 1012 in the subnetwork 2, the IP (layer-3 (L3)) tunnel 1200 is established between the wireless transmission device 1011 and the wireless transmission device 1012. A packet transmitted from the mobile terminal 1100 is attached additionally with an IP header for the IP tunnel 1200 and is thus forwarded to the wireless transmission device 1011 from the wireless transmission device 1012. With this tunneling, it follows that the data transmitted from the mobile terminal 1100 is, during the continuation of the communication session, invariably forwarded via the wireless transmission device 1011.

By taking such a scheme, also when the mobile terminal 1100 makes the handover across the subnetworks, the communications can be performed likewise in the handover destination network by use of the same IP address as before the handover, and, as a result, the communication session can continue.

A communication sequence in the conventional mobile communication system when the handover occurs across the subnetworks described above, will be explained with reference to FIG. 26. FIG. 26 is a diagram showing the communication sequence when connecting the mobile terminal in the conventional mobile communication system.

To begin with, the mobile terminal 1100, on the occasion of establishing the connection with the conventional system, acquires the IP address from the DHCP server 1001 by sending and receiving DHCP messages. The DHCP messages are a DHCP-DISCOVER message used for the mobile terminal to search for the DHCP server (S2601), a DHCP-OFFER message containing the IP address of the DHCP server and the IP address serving as an assigned candidate corresponding to the network to which the DHCP-DISCOVER message was transferred (S2602), a DHCP-REQUEST message notifying that the requester mobile terminal acquired the IP address as the assigned candidate (S2603), and a DHCP-ACK message containing a lease time and serving as an IP address assignment completion notification (S2604).

The lease time is a period of time for managing assignment time of the IP address assigned by the DHCP server 1001. If an update request is not given from the mobile terminal assigned the target IP address within the time set as this lease time, the DHCP server 1001 sets this IP address in an assignment termination status (lease status).

The mobile terminal 1100, which has thus been once assigned the IP address, thereafter, when making the handover (S2605), sends the DHCP-DISCOVER message again via the handover destination wireless transmission device 1012 (S2606). The DHCP-DISCOVER message at this time contains the IP address of the mobile terminal 1100.

The wireless transmission device 1012 receiving this DHCP-DISCOVER message, when recognizing from the mobile terminal 1100's IP address contained in the received message that the handover of the mobile terminal 1100 occurred, broadcasts a REGISTRATION-REQUEST message in order to detect the wireless transmission device that has performed the communications so far with the mobile terminal 1100 before the handover (S2607). The wireless transmission device 1011 receiving this REGISTRATION-REQUEST message, when recognizing that the device itself is the wireless transmission device performing the communications before the handover of the mobile terminal 1100, sends back the REGISTRATION-RESPONSE message containing the IP address of the device itself (S2608). Further, the wireless transmission devices 1011 and 1012 exchange the IP addresses with each other (S2609, S2610), thus establishing the IP tunnel 1200 (S2611, S2612).

When establishing the IP tunnel 1200, the wireless transmission device 1012 transfers the DHCP-DISCOVER message to the wireless transmission device 1011 via the IP tunnel 1200. The wireless transmission device 1011, when receiving the DHCP-DISCOVER message via the IP tunnel 1200, transfers this message to the DHCP server 1001 (S2614).

With this operation, the DHCP server 1001, when judging that the assigned IP address contained in the received DHCP-DISCOVER message corresponds to the subnetwork 1 to which the DHCP-DISCOVER message has been transferred, sends the DHCP-OFFER message containing the assigned IP address as it is (S2615). This DHCP-OFFER message is transferred to the wireless transmission device 1012 from the wireless transmission device 1011 via the IP tunnel 1200 and is sent to the mobile terminal 1100.

Hereafter, the DHCP-REQUEST message and DHCP-ACK message are sent and received via the IP tunnel 1200 (S2618, S2619), and it follows that the same IP address as before the handover is formally reassigned to the mobile terminal 1100.

The patent document of “Japanese Patent Application Laid-Open Publication No. 2005-27119” discloses a technology actualized in a VoIP (Voice Over IP) network as a handover processing method enabling a user of such a mobile terminal to perform the seamless communications.

In the conventional system described above, however, the communication sequence for keeping the communication session undisconnected, i.e., the operation of establishing the IP tunnel and sending and receiving the DHCP messages via the IP tunneling, expends long periods of processing time and of communication time, resulting in taking a large amount of time till user data is transferred and received since the occurrence of the handover (which will hereinafter be termed handover time). Further, in the case of encrypting the IP tunneling, a period of processing time for exchanging an encryption key is also taken, with the result that much longer handover time is expended.

### SUMMARY OF THE INVENTION

It is an object of the present invention to provide a wireless transmission device actualizing a fast handover process in an IP mobile communication network in order to solve the problems.

The present invention adopts the following configurations in order to solve the problems. Namely, the present invention is a wireless transmission device connected to any one of a plurality of subnetworks configuring an IP network including a server managing IP addresses, and connecting a mobile terminal through wireless communications to any one of the plurality of subnetworks, comprising an address storage unit storing, when mutually transferring a message about assignment of an IP address between the mobile terminal and the server, identifying information specifying the mobile terminal as a sender of the message and the IP address assigned to the mobile terminal from the server, a notifying unit notifying other wireless transmission devices, connected to the IP network, of the information stored in the address storage unit, and a proxy response unit responding, as a proxy for the server, when receiving the message sent by the mobile terminal on such an occasion that there occurs handover from one other wireless transmission device connected to the different subnetwork, a message containing the IP address, as an assigned IP address, already assigned to the mobile terminal that is the sender of the received message based on the information stored in the address storage unit.

In the present invention, the wireless transmission device associates the identifying information specifying the mobile terminal with the IP address assigned to this mobile terminal based on the message related to the IP address assignment, which is sent and received between a server and the mobile terminal, stores the associated information in the address storage unit, and distributes the stored information to the respective wireless transmission devices by the notifying unit. Namely, the individual wireless transmission devices can share the information related to the IP addresses assigned to the mobile terminals.

The wireless transmission device transmits the IP address already assigned to the mobile terminal, which is shared between the wireless transmission devices, as a response message to the IP address assignment related message sent by the mobile terminal when there occurs the handover from one other wireless transmission device connected to the different subnetwork. Namely, the wireless transmission device makes a proxy response of the should-be-assigned IP address as a proxy for the server.

This scheme is that when there occurs the handover of the mobile terminal from one other wireless transmission device connected to the different subnetwork, the wireless transmission device acts as the proxy for the server to execute the process of assigning the same IP address as the already-assigned IP address in order not to disconnect the communication session.

With this scheme, according to the present invention, when there occurs the handover of the mobile terminal from one other wireless transmission device connected to the different subnetwork, it is possible to eliminate both of the establishment of the IP tunnel conducted so as not to disconnect the communication session and of the transfer of the message related to the assignment of the IP address to the server via the IP tunneling, whereby the fast handover process can be actualized.

Note that the message concerning the assignment of the IP address may contain a server searching message for acquiring the IP address of the server and an IP address usage request message for making a request for using the IP address with respect to IP address candidates assigned from the server, these messages being sent sequentially from the mobile terminal.

Further, the message related to the assignment of the IP address may include an IP address notifying message for notifying of an assigned IP address candidate and the IP address of the server serving as a response to the server searching message, and an IP address assignment acknowledgment message serving as a response to the IP address usage request message, these messages being sent sequentially from the server.

The address storage unit further stores, for instance, an on-site flag associated with the mobile terminal, and stores identifying information specifying the mobile terminal that is a sender of the IP address assignment request message and the IP address assigned to the mobile terminal from the server, wherein the on-site flag associated with this mobile terminal is cleared when transferring the IP address notifying message to the mobile terminal, while the on-site flag associated with the mobile terminal serving as the sender of the IP address usage request message is set when transferring the IP address usage request message, and the proxy response unit may judge, when receiving the IP address assignment request message and if the on-site flag is cleared, this message as a message to be transmitted on such an occasion that the mobile terminal makes the handover from one other wireless transmission device connected to the different subnetwork.

Moreover, the wireless transmission device according to the present invention may further comprise a device list storage unit storing list information of other wireless transmission devices connected to the IP network and located in the vicinity of the self-device, and a list updating unit updating the list information based on device information transmitted from a location information server connected to the IP network and managing the location information on the plurality of wireless transmission devices, wherein the notifying unit determines the wireless transmission device that needs notifying of the information stored in the address storage unit on the basis of the list information.

With this configuration, according to the present invention, the information on the mobile terminal and the information about the IP address assigned to the mobile terminal can be shared between the wireless transmission devices in which the mobile terminal has a possibility of making the handover. To describe it conversely, these items of information are not transferred and received between the wireless transmission devices having no necessity of sharing the information, and hence it is possible to eliminate the transfer and the reception of the information unnecessary in terms of actualizing the fast handover process

Further, according to the present invention, the list information is updated with the device information transmitted from the location information server that unitarily manages the location information, and therefore the management of the list information in each of the wireless transmission devices can be reduced.

Moreover, the wireless transmission device according to the present invention may further comprise a detecting unit detecting radio waves transmitted by other wireless transmission devices connected to the IP network, wherein the list updating unit may update list information in a way that sets the wireless transmission devices transmitting the detected radio waves, as other wireless transmission devices located in the vicinity of the self-device, corresponding to intensity of the radio waves detected by the detecting unit.

With this configuration, according to the present invention, the wireless transmission device itself automatically detects one other wireless transmission device located in the vicinity thereof, and hence the list information can be automatically managed. Further, the wireless transmission device detects one other wireless transmission device through the radio waves, so that it is feasible to grasp the actual installation state and to create the list information from the ensured information.

Further, the wireless transmission device according to the present invention may further comprise an application type acquiring unit acquiring a communication application type in the continuation of a communication session on the mobile terminal that is the message sender from the message sent by the mobile terminal, wherein the notifying unit may notify of only the information on the mobile terminal of which the acquired communication application type is the specified communication application in items of information stored in the address storage unit, and the proxy response unit may make the proxy response only about the mobile terminal of which the acquired communication application type is the specified communication application.

The communication application type connoted herein may indicate a protocol type of the protocol executed on the application layer (the seventh layer) based on, e.g., an OSI (Open Systems Interconnection) hierarchical model. Further, the specified communication application indicates, for example, a communication application in a realtime system in which a service to be provided is affected when the communication session is disconnected and is exemplified by SIP (Session Initiation Protocol).

According to the present invention, only the information on the mobile terminal executing the specified communication application is shared between the wireless transmission devices, and hence there is not made any proxy response about the IP address assignment related message sent by the mobile terminal executing the communication application other than the specified communication application.

With this scheme, according to the present invention, it is possible to make the proxy response only about the mobile terminal executing the communications having a possibility of affecting the communication service due to the disconnection of the communication session, and it is therefore feasible to execute the proxy response that narrows down the communication services.

Moreover, in the wireless transmission device according to the present invention, the application type acquiring unit may further acquire a termination status of a communication application indicated by the acquired communication application, and the proxy response unit, when the acquired communication application type is the specified communication application and when receiving a message requesting a continuous usage of the assigned IP address in messages sent from the mobile terminal of which the communication application comes to the termination status, may discard the message requesting the continuous usage of the received IP address without transferring this message.

In the present invention, when the communication application having the possibility of affecting the communication service due to the disconnection of the communication session comes to the termination status, the proxy response is stopped, and the received message requesting the continuous usage of the IP address is discarded without being transferred to the server. As a result, in the mobile terminal, it is judged that the IP address can not be continuously used, and an IP address corresponding to the subnetwork to which the handover destination wireless transmission device is connected, is newly assigned.

Therefore, according to the present invention, the IP tunnel is established only about the message sent from the mobile terminal in the continuation of the communication application having the possibility of affecting the communication service due to the disconnection of the communication session, and it is therefore possible to actualize the fast handover process in a way that narrows down the communication services.

It should be noted that the present invention may also be a program for actualizing any one of the functions given above. Moreover, the present invention may also be a readable-by-computer recording medium recorded with such a program.

According to the present invention, it is possible to provide the wireless transmission device actualizing the fast handover process in the IP mobile communication network.

### BRIEF DESCRIPTION OF THE DRAWINGS

FIG. 1 is a diagram showing a network configuration of a mobile communication system;

FIG. 2 is a diagram showing a functional configuration of the wireless transmission device;

FIG. 3 is a diagram showing a DHCP packet format;

FIG. 4 is a diagram showing a DHCP cache table;

FIG. 5 is a diagram showing a neighboring device list;

FIG. 6 is a diagram showing a packet format of DHCP information advertisement;

FIG. 7 is a diagram showing an operating sequence of a mobile communication system;

FIG. 8 is a diagram showing a processing flow of a DHCP proxy response agent;

FIG. 9 is a diagram showing a processing flow of the DHCP proxy response agent;

FIG. 10 is a diagram showing a network configuration of a mobile communication system in a second embodiment;

FIG. 11 is a diagram showing a functional configuration of a management server device;

FIG. 12 is a diagram showing a neighboring group list;

FIG. 13 is a diagram showing a processing flow of a configuration management unit;

FIG. 14 is a diagram showing a network configuration of a mobile communication system in a third embodiment;

FIG. 15 is a diagram showing a functional configuration of the wireless transmission device in the third embodiment;

FIG. 16 is a diagram showing a neighboring device list in the third embodiment;

FIG. 17 is a diagram showing a processing flow of the wireless transmission device in the third embodiment;

FIG. 18 is a diagram showing a processing flow of the wireless transmission device in a fourth embodiment;

FIG. 19 is a diagram showing a DHCP cache table in the fourth embodiment;

FIG. 20 is a diagram showing a functional configuration of the wireless transmission device in a modified example of the fourth embodiment;

FIG. 21 is a diagram showing the DHCP cache table in the modified example of the fourth embodiment;

FIG. 22 is a diagram showing a processing flow of the wireless transmission device in the modified example of the fourth embodiment;

FIG. 23 is a diagram showing an IP address releasing process;

FIG. 24 is a diagram showing a network configuration of a conventional mobile communication system;

FIG. 25 is a diagram showing the conventional mobile communication system using a proxy DHCP system; and

FIG. 26 is a diagram showing an operating sequence of the conventional mobile communication system.

### DESCRIPTION OF THE PREFERRED EMBODIMENTS

Each of wireless transmission devices in respective embodiment of the present invention will hereinafter be described with reference to the drawings. It should be noted that configurations in the following embodiments are exemplifications, and the present invention is not limited to the configurations in the embodiments.

### First Embodiment

A mobile communication system (which will hereinafter be simply referred to as the system) configured by the wireless transmission devices in a first embodiment of the present invention, will hereinafter be explained.

### System Architecture

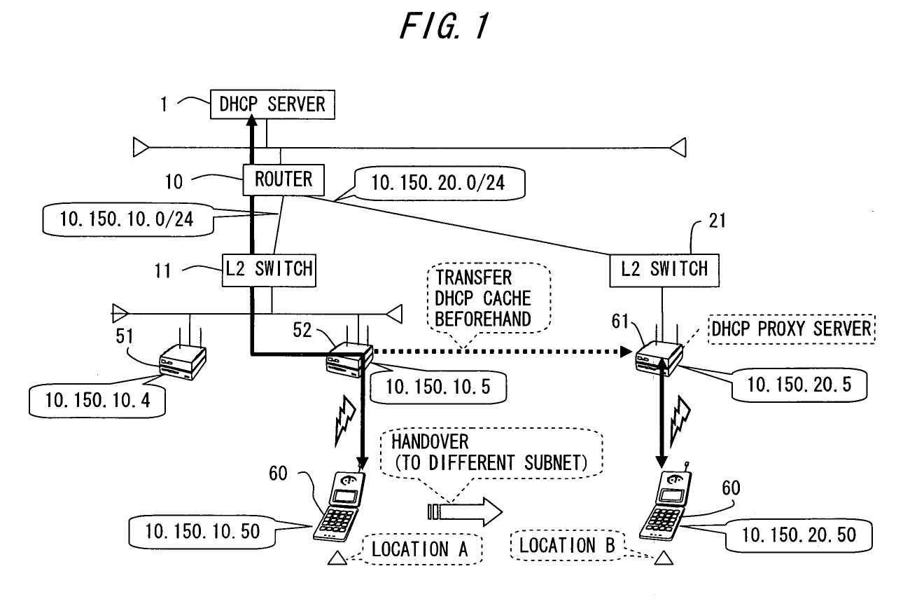

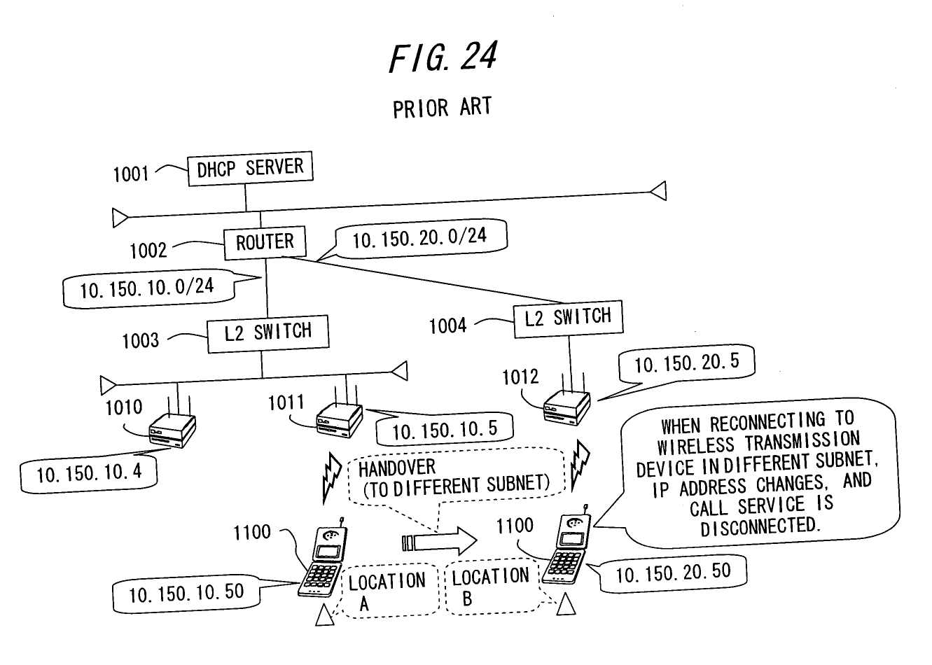

To start with, a network configuration of the system will be described with reference to FIG. 1. FIG. 1 is a diagram showing the system architecture of the mobile communication system in the first embodiment. It is to be noted that the system shall have the same architecture as the architecture illustrated in FIG. 24, which is given in the item of Background Art for the explanatory convenience's sake but is not limited to such an architecture.

The system includes a DHCP (Dynamic Host

Configuration Protocol) server 1, a router 10, layer-2 switches (which will hereinafter simply termed L2 switches) 11 and 21, and wireless transmission devices 51, 52 and 61. Then, in the system, the wireless transmission devices 51, 52, 60 perform communications with an IP mobile terminal (which will hereinafter be referred to as a mobile terminal) 60, whereby the IP mobile terminal 60 connects the system.

Further, in the system, respective nodes are assigned unique IP addresses and are connected, thus configuring an IP network. Moreover, this IP network is segmented into a subnetwork 1 (assigned a network address [10.150.10.0]) to which the wireless transmission devices 51, 52 and the L2 switch 11 are connected, and into a subnetwork 2 (assigned a network address [10.150.20.0]) to which the wireless transmission device 61 and the L2 switch 21 are connected. Then, IP packets forwarded to and received from the subnetworks 1, 2 are routed to the router 10.

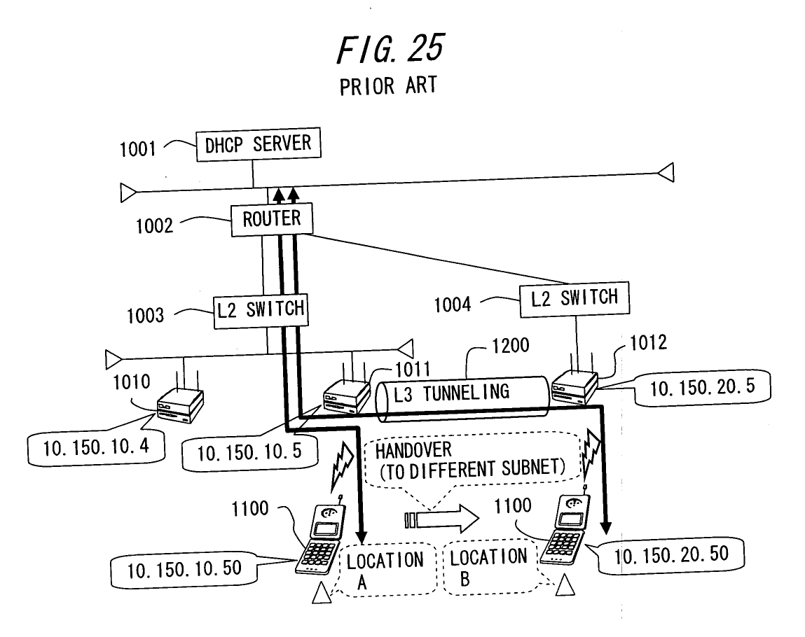

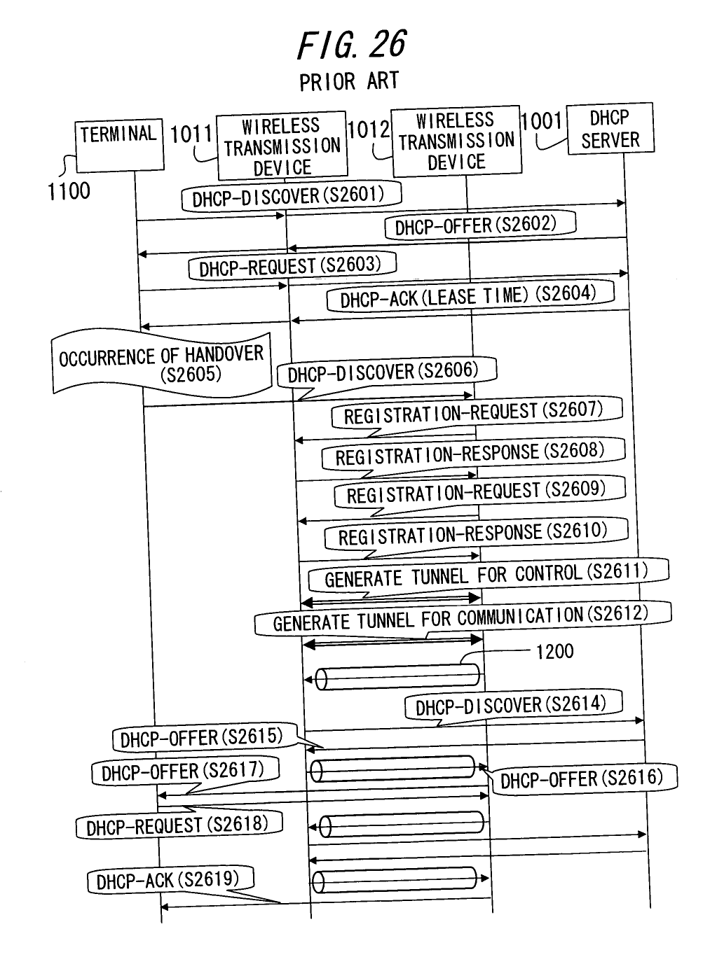

Each of the nodes configuring the system will be explained. Note that the nodes excluding the wireless transmission devices 51, 52 and 61 may, it is sufficient, have general functions (see FIGS. 24 through 26) corresponding to types of respective pieces of equipment, and, since these functions are not limited by the present invention, the explanations of the individual nodes are simplified.

The DHCP server 1 has a function as a general type of DHCP server. To be specific, the DHCP server 1 sends and receives a DHCP message to and from the mobile terminal 60, thereby assigning the mobile terminal 60 an IP address corresponding to the subnetwork to which the wireless transmission device connected to the mobile terminal 60 belongs. The DHCP server 1, when assigning the IP address, determines the to-be-assigned IP address based on a network address to which a DHCP-DISCOVER message is transferred at that time. Further, the DHCP server 1, when sending a DHCP-ACK message, monitors assignment time of the IP address assigned in lease time contained in this message.

The L2 switch 11 and the L2 switch 21 are devices such as switching hubs that relay data packets on a so-called data link layer (Layer 2). The router 10 is a relay device for connecting the subnetwork 1 and the subnetwork 2 to the network to which the DHCP server 1 is connected, and forwards the data packet on a network layer or a transport layer, corresponding to protocols which these networks are configured based on.

Further, the mobile terminal 60 has an IP packet communication function and a wireless communication function. The mobile terminal 60 performs wireless communications with each wireless transmission device that covers its terminal existing location as a communication area, corresponding to this existing location. The mobile terminal 60 acquires, from the DHCP server 1, the IP address corresponding to the network to which the wireless transmission device performing the wireless communications belongs, and conducts the IP packet communications by use of this IP address.

### Wireless Transmission Device

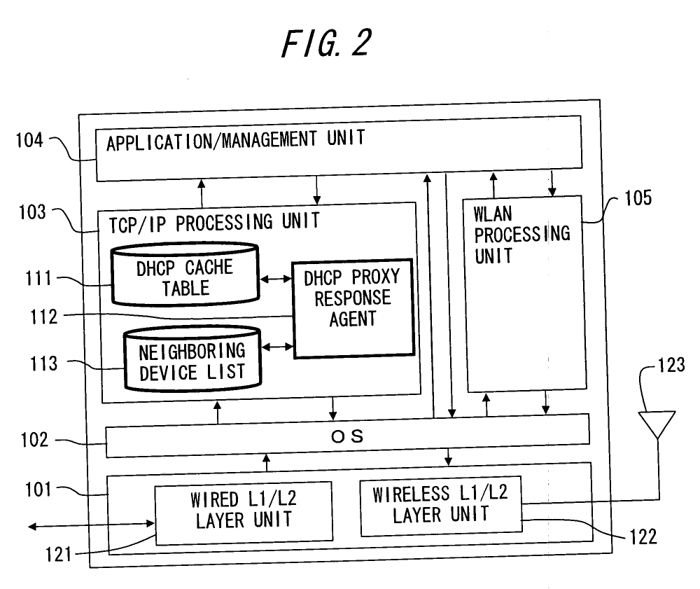

The wireless transmission device 51 (having the same function as the wireless transmission devices 52 and 61 have) receives the IP packet as carried on radio waves from the mobile terminal 60. The wireless transmission device 51 forwards the received IP packet to the IP network connected by a cable. Further, the wireless transmission device 51 establishes an IP tunnel between the wireless transmission device 51 and one other wireless transmission device, corresponding to handover of the mobile terminal 60. A functional configuration of the wireless transmission device 51 will be explained with reference to FIG. 2. FIG. 2 is a diagram showing the functional configuration of the wireless transmission device.

As shown in FIG. 2, the wireless transmission device 51 includes a network interface unit 101, an OS (Operating System) unit 102, a TCP/IP (Transmission Control Protocol/Internet Protocol) processing unit 103, a WLAN (Wireless Local Area Network) processing unit 105, and an application/management unit 104. The functions thereof are actualized by a CPU (Central Processing Unit), a memory, an input/output interface (unillustrated), etc, which are implemented in the wireless transmission device 51. It should be noted that the function units other than the TCP/IP processing unit 103 in those function units may, it is sufficient, have general functions corresponding to these respective functions, and, since these functions are not limited by the present invention, the explanations of the functions are simplified.

The network interface unit 101 has a wireless L1/L2 layer unit 122 actualizing a wireless communication system defined by IEEE802.11 etc and a wired L1/L2 layer unit 121 actualizing a wired communication system defined by IEEE802.3 etc, wherein these layer units 122 and 121 actualize a communication protocol on the physical layer and a communication protocol on the data link layer. The WLAN processing unit 105 controls the wireless communications with the mobile terminal 60 and with this device. The application/management unit 104 is an application that utilizes transmitting/receiving data processed by the respective functions, and is a function unit having a function of managing the WLAN processing unit 105 and the TCP/IP processing unit 103.

The TCP/IP processing unit 103 is a function unit that controls the communication packets transmitted and received based on the TCP/IP. The TCP/IP processing unit 103 includes, for actualizing the present invention, particularly a DHCP cache table 111, a DHCP proxy response agent (which will hereinafter be also simply termed an agent) 112 and a neighboring device list 113. It should be noted that the TCP/IP processing unit 103 may include, in addition to these function units, a function for actualizing a general TCP/IP process but is not restricted to these function units.

### DHCP Proxy Response Agent

The agent 112 assigns, when the handover of the mobile terminal 60 occurs, the IP address in a way that acts as a proxy for the DHCP server 1. Namely, the agent 112, when receiving the DHCP message serving as an IP address assignment request when the handover of the mobile terminal 60 occurs, acquires an IP address before the handover of the mobile terminal 60, and responds with sending the DHCP message for assigning the IP address to the mobile terminal 60. This function will hereinafter be termed a DHCP proxy response.

The agent 112 retains, in the DHCP cache table 111, the DHCP information transferred and received between the mobile terminal 60 and the DHCP server 1 before the handover. The agent 112 actualizes the DHCP proxy response function by referring to the DHCP cache table 111.

Further, the agent 112 advertises the DHCP information retained in the DHCP cache table 111 to a neighboring wireless transmission device. This function will hereafter be referred to as a DHCP information advertisement. At this time, the agent 112 obtains, based on the information stored in the neighboring device list 113, the neighboring wireless transmission device.

### DHCP Cache Table

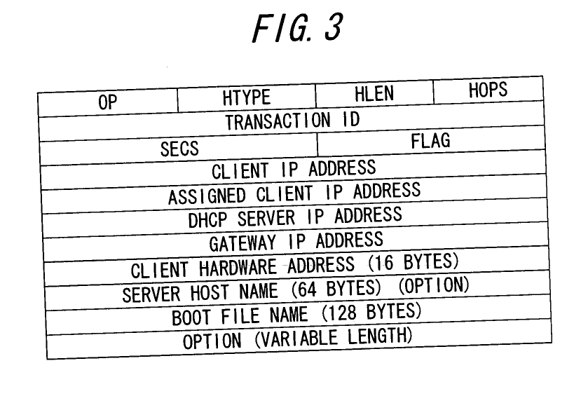

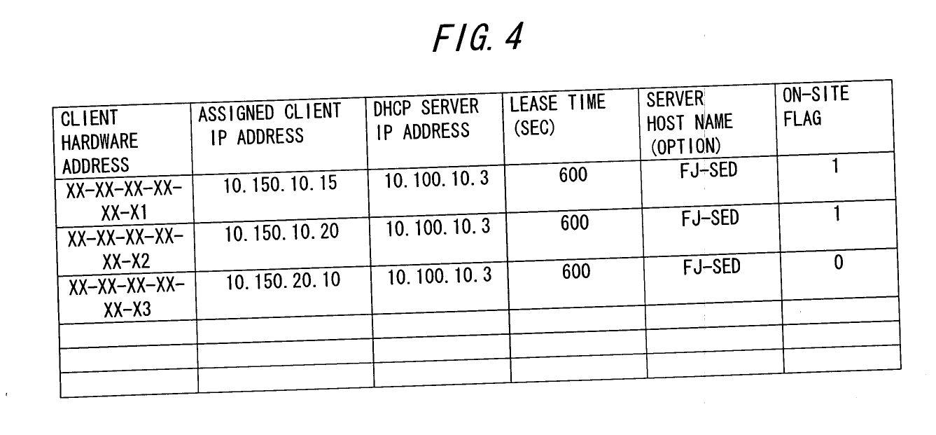

The DHCP cache table 111 is stored in a memory etc of the wireless transmission device 51 and is registered with the DHCP information transferred and received through the DHCP message between the mobile terminal 60 and the DHCP server 1. FIG. 3 is a diagram showing a format of a DHCP packet. FIG. 4 is a diagram showing the DHCP cache table 111. This DHCP cache table 111 will hereinafter be explained with reference to FIGS. 3 and 4.

The DHCP cache table 111 is registered with items of information such as a client hardware address, an assigned client IP address, a DHCP server IP address, lease time and an on-site flag.

The client hardware address field is registered with a hardware address for specifying each mobile terminal. This hardware address is, e.g., a piece of identifying information (ID) stored in a wireless communication interface chip held by the mobile terminal and is the ID assigned to one piece of wireless communication interface chip. The client hardware address contained in a DHCP-OFFER message sent from the DHCP server 1 is set in this client hardware address field (see FIG. 3).

Set in the assigned client IP address field is an IP address assigned from the DHCP server 1. An assigned IP address contained in the DHCP-OFFER message sent from the DHCP server 1 is set in this assigned client IP address field (see FIG. 3).

An IP address of the DHCP server 1 is set in the DHCP server IP address field. A DHCP server address set in the DHCP-OFFER message, transferred from the DHCP server 1, is set in this DHCP server IP address field (see FIG. 3).

Set in the lease time field is assignment time set in the IP address, which is issued when the DHCP server 1 assigns the IP address. The lease time contained in the DHCP-ACK message sent from the DHCP server 1 is set as it is in this lease time field.

The wireless transmission device 51 manages the information set in the DHCP cache table 111 in accordance with the lease time set in the lease time field. Specifically, the wireless transmission device 51 monitors each lease time, corresponding to the assigned client IP address, and, if there is not given any lease update request through a DHCP-REQUEST message of the terminal during a period of this lease time, deletes a corresponding record from the DHCP cache table 111.

Set in the on-site flag field is a value representing whether or not there is a necessity of making the DHCP proxy response to the mobile terminal specified by the target record. In the first embodiment, when [0] is set in this on-site flag field, it is judged to have the necessity of making the DHCP proxy response and, when [1] is set in this field, it is judged not to have the necessity of making the DHCP proxy response. Hereafter, a process of setting [0] in the on-site flag field will be expressed such as “clear the on-site flag”, and a process of setting [1] in the on-site flag field will be expressed such as “set the on-site flag”.

When receiving the DHCP-REQUEST message sent from the mobile terminal 60, [1] is set in this on-site flag field. Further, this on-site flag field is updated when receiving a DHCP information advertisement from a different wireless transmission device. The agent 112 clears the on-site flag in the record containing the assigned IP address outside the self-belonging subnetwork in the advertised DHCP information.

Moreover, this on-site flag field may also be utilized for judging whether or not an IP tunnel needs establishing between the self-device and other wireless transmission devices. In this case, a scheme may be such that if this on-site flag field has already been cleared, it is judged that the IP tunnel needs establishing, and, if the on-site flag field has already been set, it is judged that the IP tunnel does not need establishing.

Note that a server host name field, in which a host name of the DHCP server 1 is entered, may also be complementarily provided in this DHCP cache table 111.

### Neighboring Device List

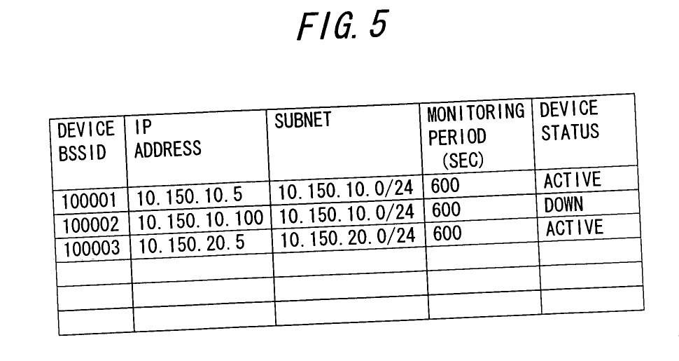

The neighboring device list 113 is stored in the memory etc of the wireless transmission device and is registered with items of information on the neighboring wireless transmission device to which need to transfer the DHCP information advertisement. The neighboring device list 113 may also be preset by, e.g., a system administrator or a system maintenance technician employing an input/output terminal (unillustrated) etc. FIG. 5 is a diagram showing the neighboring device list. This neighboring device list 113 will hereinafter be described with reference to FIG. 5.

The neighboring device list 113 is registered with items of information such as a device BSSID (Basic Service Set Identifier), an IP address, a subnetwork address, a monitoring period and a device status.

A hardware address for specifying each wireless transmission device is entered in the device BSSID field. This hardware address involves using, for example, as in the case of a MAC (Media Access Control) address, identifying information (ID) stored in the communication chip configuring the wired L1/L2 layer unit 121 of the wireless transmission device and also an ID assigned to a single piece of communication interface chip.

An IP address set in each wireless transmission device is set in the IP address field. An IP address of the subnetwork to which each wireless transmission device belongs, is set in the subnetwork address field. Note that thus subnetwork address may also be extracted from the IP address of each wireless transmission device without providing this subnetwork address field.

The monitoring period field and the device status field are complementary fields and are fields used for monitoring a device status of each wireless transmission device. The device status of each wireless transmission device is entered in the device status field, and the monitoring period for monitoring the device status of each wireless transmission device is entered in the monitoring period field. The agent 112 may advertise the DHCP information to only the wireless transmission device specified by the record containing [ACTIVE] (on-operating) that is set in this device status field.

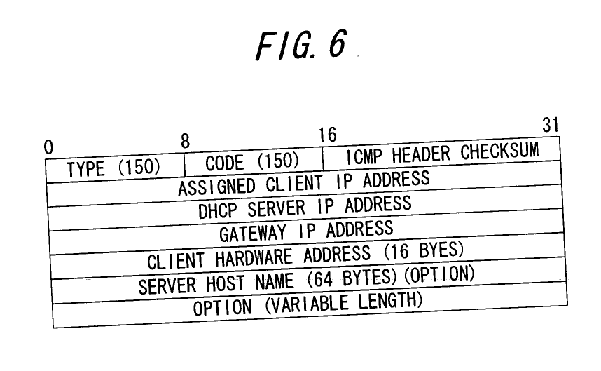

Note that the agent 112 may advertise the DHCP information in a message format, shown in FIG. 6, into which an ICMP (Internet Control Message Protocol) packet format is extended. FIG. 6 is a diagram showing a packet format of the DHCP information advertisement. The ICMP packet shown in FIG. 6 is a packet, wherein a message type and a code of the ICMP packet are extended for the DHCP information advertisement (message type=150, code=150).

The agent 112 sets, in the DHCP information advertisement packet, the client hardware address, the assigned client IP address, the DHCP server IP address and the server host name in the items of information retained in the DHCP cache table 111, and transmits this packet to the neighboring wireless transmission device. Further, this type of DHCP information advertisement may be transferred and received based on an original protocol.

### Operational Example

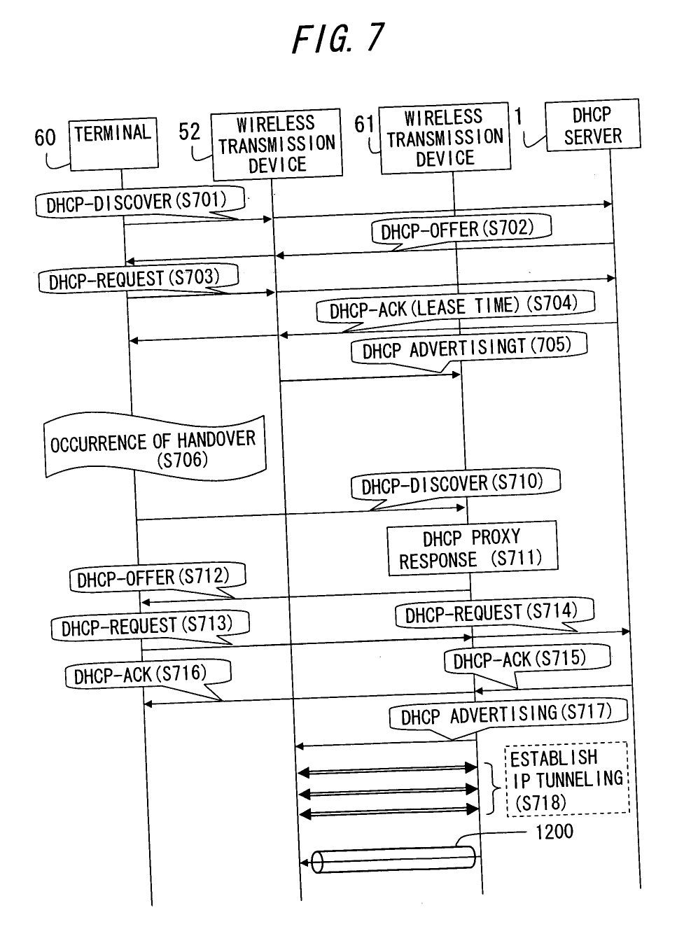

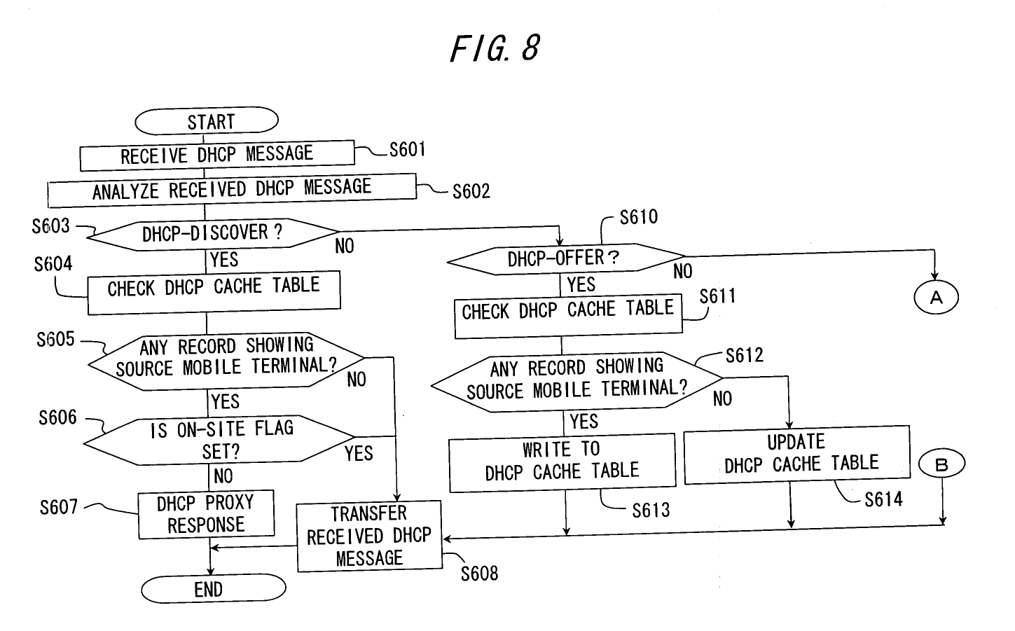

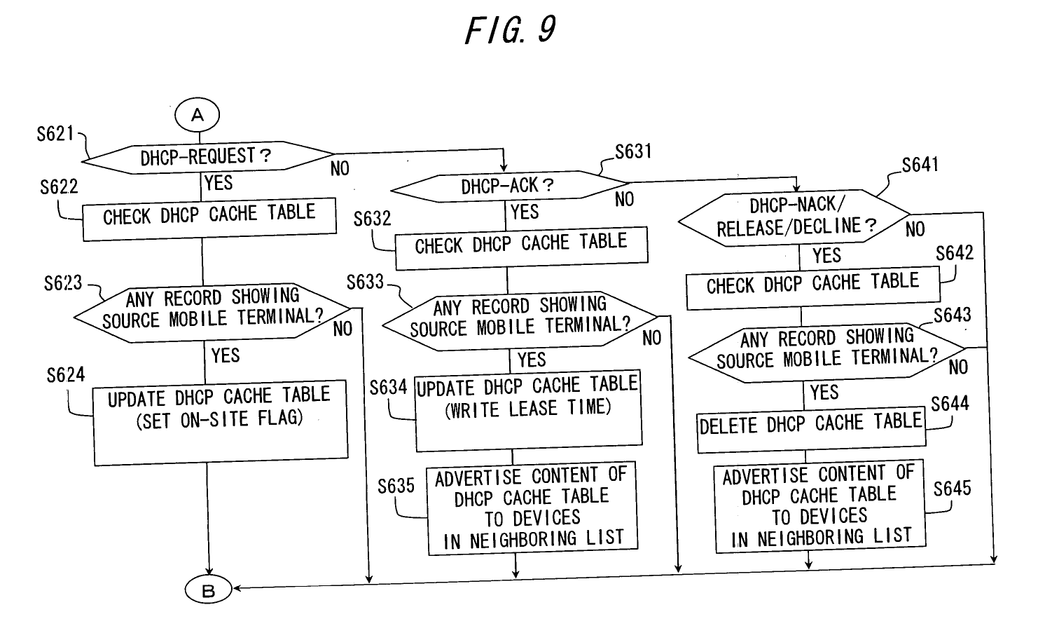

Next, an operational example of the wireless transmission device in the first embodiment will be explained with reference to FIGS. 7 through 9. FIG. 7 is a diagram showing a communication sequence in the mobile communication system. FIGS. 8 and 9 are flowcharts each showing the operational example of the wireless transmission device in the first embodiment.

To begin with, the communication sequence in the mobile communication system will be described with reference to FIG. 7. The mobile terminal 60, when starting the communications on the occasion of being located at a location A illustrated in FIG. 1, connects to the mobile communication system by performing the wireless communications with the wireless transmission device 52. The mobile terminal 60 connects to the mobile communication system for the first time at this moment, and hence any record related to the mobile terminal 60 is not retained in the DHCP cache table 111 of each of the wireless transmission devices 51, 52 and 61.

The mobile terminal 60 sends and receives the DHCP message to and from the DHCP server 1 via the wireless transmission device 52 (S701 through S704), thereby acquiring the IP address [10.150.10.50] corresponding to the subnetwork to which the wireless transmission device 52 belongs.

At this time, the wireless transmission device 52 extracts predetermined items of information from the DHCP message sent and received between the mobile terminal 60 and the DHCP server 1, thus adding the record related to the mobile terminal 60 to the DHCP cache table 111. To give an in-depth description, the record related to the mobile terminal 60 is added to the DHCP cache table 111 when receiving the DHCP-OFFER message from the DHCP server 1 (S702), the on-site flag field in the added record is set when receiving the DHCP-REQUEST message (S703), and the lease time field in the added record is updated when receiving the DHCP-ACK message (S704).

The wireless transmission device 52, after transferring the DHCP-ACK message to the mobile terminal 60 (after updating the lease time field in the DHCP cache table 111), notifies the neighboring wireless transmission devices (e.g., the wireless transmission devices 51 and 61), stored in the neighboring device list 113, of the information in the DHCP cache table 111 (S705).

The wireless transmission device 61 receiving this DHCP information clears the on-site flag in the record associated with the mobile terminal, which contains the setting of the IP address of the different subnetwork, in the items of information on the mobile terminal that is contained in the DHCP information, and sets the on-site flag in the record associated with the mobile terminal, which contains the setting of the IP address of the same subnetwork.

The mobile terminal 60, upon an occurrence of the handover to the wireless transmission device 61 from the wireless transmission device 52 to which the mobile terminal 60 has been connected so far (S706), resends the DHCP-DISCOVER message (S710). The wireless transmission device 61, when receiving this DHCP-DISCOVER message, refers to the DHCP cache table 111 and thus judges whether the DHCP proxy response should be made or not. The wireless transmission device 61, when the record related to the mobile terminal 60 exists in the DHCP cache table 111 and when clearing the on-site flag field in this record, judges that the DHCP proxy response should be made (S711).

The wireless transmission device 61, when judging that the DHCP proxy response should be made, extracts the predetermined items of information (the client hardware address, the assigned client IP address, the DHCP server IP address, the server host name) from the corresponding record in the DHCP cache table 111, and sends the DHCP-OFFER message containing the setting of these items of information to the mobile terminal 60 (DHCP proxy response) (S712). At this time, the IP address [10.150.10.50] is set in the assigned client IP address (field).

The mobile terminal 60 receiving the DHCP-OFFER message sends the DHCP-REQUEST message as a permission notification of using this assigned IP address (S713). The wireless transmission device 61 receiving the DHCP-REQUEST message sets the on-site flag in the record related to the mobile terminal 60 in the DHCP cache table 111, and transfers this DHCP-REQUEST message towards the DHCP server 1 (S714). The DHCP-REQUEST message transferred by the wireless transmission device 61 is sent in a way that sets a broadcast address as a destination address in this message.

The DHCP server 1, when receiving the DHCP-REQUEST message that has been broadcast, sends the DHCP-ACK message containing the lease time (S715). The DHCP-ACK message sent by the DHCP server 1 is sent in a way that sets a broadcast address as a destination address in this message.

The wireless transmission device 61 receiving this DHCP-ACK message, when judging that this message is a response to the DHCP-REQUEST message transferred by the wireless transmission device 61 itself, updates the lease time in the record related to the mobile terminal 60 in the DHCP cache table 111 into the lease time contained in this DHCP-ACK message. Thereafter, the wireless transmission device 61 sends this DHCP-ACK message to the mobile terminal 60 (S716).

The wireless transmission device 61, after transferring the DHCP-ACK message to the mobile terminal 60 (after updating the lease time field in the DHCP cache table 111), notifies the neighboring wireless transmission devices (e.g., the wireless transmission devices 51 and 52), stored in the neighboring device list 113, of the information in the DHCP cache table 111 (S717).

Note that the wireless transmission device 61, upon receiving the DHCP-DISCOVER message, establishes an IP tunnel 1200 between the wireless transmission device 61 itself and the wireless transmission device 52 defined as a handover source device in parallel with the DHCP proxy response (S711) (S718). The establishment of this IP tunnel 1200 is actualized in the same procedures as those described in Background Art.

### Explanation of Operating Flow

Next, an operation of the DHCP proxy response agent 112 of the wireless transmission device in the first embodiment will hereinafter be described with reference to FIGS. 8 and 9.

The agent 112, when receiving the DHCP message from the network interface unit 101 (the wired L1/L2 layer unit 121 or the wireless L1/L2 layer unit 122) (S601), analyzes this received DHCP message (S602). The agent 112 acquires, based on this analysis, the DHCP message type, the client IP address, the client hardware address, etc from the received DHCP message.

Note that there are, depending on its message type, a case where the DHCP message is transmitted by the DHCP server 1 and is received by the wired L1/L2 layer unit 121 and a case where the DHCP message is wirelessly transmitted from the mobile terminal 60 and is received by the wireless L1/L2 layer unit 122. For instance, the DHCP-DISCOVER message and the DHCP-REQUEST message are transmitted from the mobile terminal 60, while the DHCP-OFFER message and the DHCP-ACK message are transmitted from the DHCP server 1.

The agent 112, when judging based on the acquired information that the received DHCP message is the DHCP-DISCOVER message (S603; YES), checks the DHCP cache table 111 (S604). The agent 112, when confirming that the acquired client hardware address is registered in the DHCP cache table 111 (S603; YES), further checks the on-site flag in the related record in the DHCP cache table 111 (S605).

The agent 112, when confirming that the on-site flag is cleared (S605; NO), makes the DHCP proxy response (S605). Namely, the agent 112 extracts the assigned client IP address and the DHCP server IP address and the server host name from this record in the DHCP cache table 111, and sends the DHCP-OFFER message containing the setting of theses items of information to the mobile terminal defined as the DHCP message sender.

On the other hand, the agent 112, when confirming that the acquired client hardware address is not yet registered in the DHCP cache table 111 (S603; NO), transfers the DHCP-DISCOVER message towards the DHCP server 1 (S608). Further, the agent 112, when confirming that the on-site flag in the DHCP cache table 111 is set (S605; YES), transfers the DHCP-DISCOVER message towards the DHCP server 1 (S608). In this case, it follows that the DHCP-DISCOVER message received from the mobile terminal is the message sent when the handover occurs within the same subnetwork.

When judging that the received DHCP message is the DHCP-OFFER message (S603; N0, S610; YES), the agent 112 checks the DHCP cache table 111 (S611). The agent 112, when confirming that the acquired client hardware address is registered in the DHCP cache table 111 (S612; YES), reflects the assigned client IP address, the DHCP server IP address, etc contained in the DHCP-OFFER message in the related record in the DHCP cache table 111 (S613).

While on the other hand, the agent 112, when confirming that the acquired client hardware address is not yet registered in the DHCP cache table 111 (S612; NO), adds a new record to the DHCP cache table 111, and reflects the client hardware address, the assigned client IP address, the DHCP server IP address, the client hardware address, the server host name, etc contained in the DHCP-OFFER message in the added record (S614).

Thereafter, the agent 112 wirelessly transmits the DHCP-OFFER message to the mobile terminal (S608).

When judging that the received DHCP message is the DHCP-REQUEST message (S603; N0, S610; N0, S621; YES), the agent 112 checks the DHCP cache table 111 (S622). The agent 112, when confirming that the acquired client hardware address is registered in the DHCP cache table 111 (S623; YES), sets the on-site flag in the related record in the DHCP-cache table 111 (S624).

While on the other hand, the agent 112, when confirming that the acquired client hardware address is not yet registered in the DHCP cache table 111 (S623; NO) broadcasts the DHCP-REQUEST message towards the DHCP server 1 (S608).

When judging that the received DHCP message is the DHCP-ACK message (S603; N0, S610; N0, S621; N0, S631; YES), the agent 112 checks the DHCP cache table 111 (S632). The agent 112, when confirming that the acquired client hardware address is registered in the DHCP cache table 111 (S633; YES), reflects the lease time contained in the DHCP-ACK message in the related record in the DHCP cache table 111 (S634).

Thereafter, the agent 112 advertises the information in the DHCP cache table 111 to the neighboring wireless transmission devices retained in the neighboring device list 113 (S635). While on the other hand, the agent 112, when confirming that the acquired client hardware address is not yet registered in the DHCP cache table 111 (S633; NO), wirelessly transmits the DHCP-ACK message to the mobile terminal (S608).

When judging that the received DHCP message is a DHCP-NACK/DHCP-RELEASE/DHCP-DECLINE message (S603; NO, S610; NO, S621; NO, S631; NO, S641; YES), the agent 112 checks the DHCP cache table 111 (S642). The agent 112, when confirming that the acquired client hardware address is registered in the DHCP cache table 111 (S643; YES), deletes the related record from the DHCP cache table 111 (S644).

Thereafter, the agent 112 advertises the information in the DHCP cache table 111 to the neighboring wireless transmission devices retained in the neighboring device list 113 (S645). On the other hand, the agent 112, when confirming that the acquired client hardware address is not yet registered in the DHCP cache table 111 (S643; NO), transfers the DHCP message to the mobile terminal or the DHCP server 1 (S608). Note that in the case of a message other than the messages described above, this message is transferred as it is to the mobile terminal or the DHCP server 1 (S608).

### Operation/Effect in First Embodiment

Herein, an operation and an effect of the wireless transmission device in the first embodiment discussed above will be explained.

In the wireless transmission device in the first embodiment, when the mobile terminal 60 connects to the mobile communication system, the DHCP message sent and received to and from the DHCP server 1 is analyzed when relayed, whereby the client IP address, the client hardware address, etc are extracted from this message and retained in the DHCP cache table 111.

Further, the DHCP information retained in this DHCP cache table 111 is advertised to the neighboring wireless transmission devices retained in the neighboring device list 113, whereby it follows that the IP addresses of the mobile terminals connected to the mobile communication system, assigned by the DHCP server 1, is shared among the wireless transmission devices located in the vicinity thereof.

Thereafter, in the wireless transmission device, when the DHCP-DISCOVER message is received, the DHCP cache table 111 is referred to, thus confirming that the client hardware address specifying the mobile terminal serving as the message sender is registered in the DHCP cache table 111 and that the on-site flag in the related record in the DHCP cache table 111 is cleared. With this operation, when confirming that the on-site flag is cleared, the client IP address, the DHCP server IP address and the server host name are extracted from the related record in the DHCP cache table 111, and the DHCP-OFFER message containing the setting of these items of information is transmitted to the mobile terminal (the DHCP proxy response is made).

This on-site flag is the flag utilized for promptly judging whether or not it is necessary for the wireless transmission device to give the DHCP proxy response to the mobile terminal. The on-site flag is set when receiving the DHCP-REQUEST message sent from the mobile terminal 60 (when the proper IP address has already been assigned), and there is cleared the on-site flag in the record specifying the mobile terminal assigned the IP address outside the subnetwork to which the self-device belongs in the case of receiving the DHCP information advertisement from other wireless transmission devices.

With this scheme, according to the wireless transmission device in the first embodiment, in the case of receiving the DHCP-DISCOVER message sent upon the occurrence of the handover of the mobile terminal 60 from one other wireless transmission device connected to the different subnetwork, it is possible to establish the IP tunnel for keeping the communication session seamlessly and to eliminate the transfer of the DHCP-DISCOVER message to the DHCP server 1 via the IP tunneling.

Further, the judgment of the proxy response can be also made promptly by referring to the DHCP cache table 111.

Hence, according to the wireless transmission device in the first embodiment, the fast handover process can be actualized.

### Second Embodiment

A mobile communication system configured by wireless transmission devices in a second embodiment of the present invention will hereinafter be described. In the wireless transmission device in the first embodiment discussed earlier, the neighboring device list 113 is preset by the system administrator or the system maintenance technician by use of the I/O terminal etc.

A scheme of the mobile communication system in the second embodiment is that the neighboring device list 113 of the respective wireless transmission devices is automatically distributed by providing a management server for managing batchwise a connecting configuration between the wireless transmission devices in the system. A configuration in the second embodiment, which will hereinafter be discussed, is an exemplification, and the present invention is not limited to the following configuration.

### System Architecture

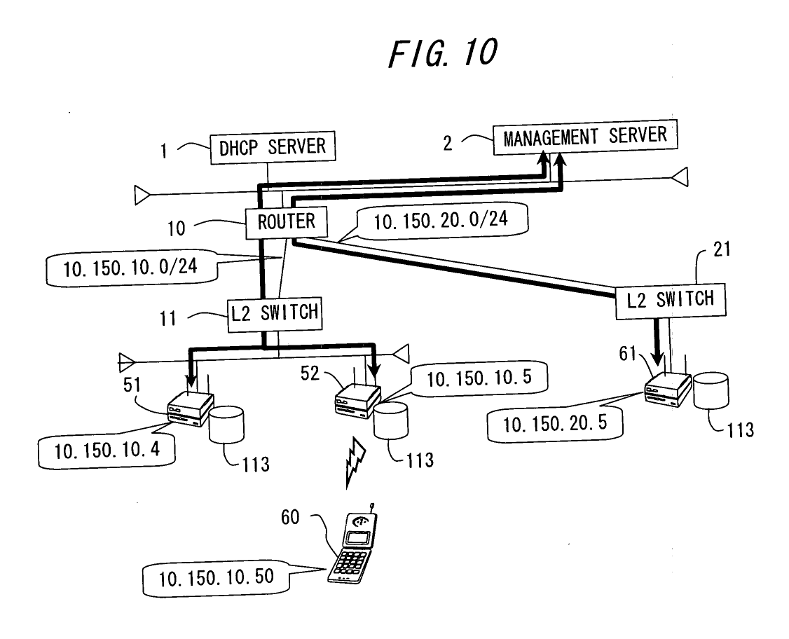

A network configuration of the mobile communication system in the second embodiment will hereinafter be described with reference to FIG. 10. FIG. 10 is a diagram showing the network configuration of the mobile communication system in the second embodiment. The mobile communication system in the second embodiment further include a management server 2 as an addition to the mobile communication system in the first embodiment, and devices other than the management server 2 are the same as those in the first embodiment. It should be noted that the wireless transmission device in the second embodiment newly has a function of receiving pieces of neighboring device list information sent from the management server 2 and updating its own neighboring device list 113 on the basis of the neighboring device list information.

### Management Server

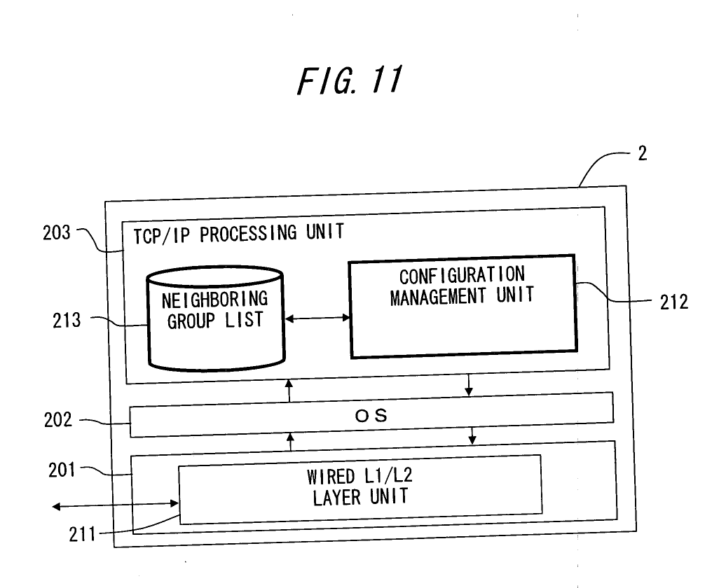

The management server 2 manages the configuration information of the wireless transmission devices within the system, and respectively generates, based on the configuration information, the neighboring device list with respect to each of the wireless transmission devices. The management server 2 distributes the thus-generated neighboring device list to each of the wireless transmission devices. A functional configuration of the management server 2 will hereinafter be explained with reference to FIG. 11. FIG. 11 is a diagram showing the functional configuration of the management server 2.

As shown in FIG. 11, the management server 2 includes a network interface unit 201, an OS unit 202 and a TCP/IP processing unit 203. The functions thereof are actualized by a CPU, a memory, an input/output interface (unillustrated), etc, which are implemented in the management server 2. It should be noted that the function units other than the TCP/IP processing unit 203 in those function units may, it is sufficient, have general functions corresponding to these respective functions, and, since these functions are not limited by the present invention, the explanations of the functions are simplified.

The network interface unit 201 has a wired L1/L2 layer unit 211 actualizing the wired communication system defined by IEEE802.3 etc, wherein the layer units 211 actualized the communication protocol on the physical layer and the communication protocol on the data link layer.

The TCP/IP processing unit 203 is a function unit that controls the communication packets transmitted and received based on the TCP/IP. The TCP/IP processing unit 203 includes, for actualizing the present invention, particularly a configuration management unit 212 and a neighboring group list 213. It should be noted that the TCP/IP processing unit 203 may include, in addition to these function units, a function for actualizing the general TCP/IP process but does not limit these function units.

### Neighboring Group List

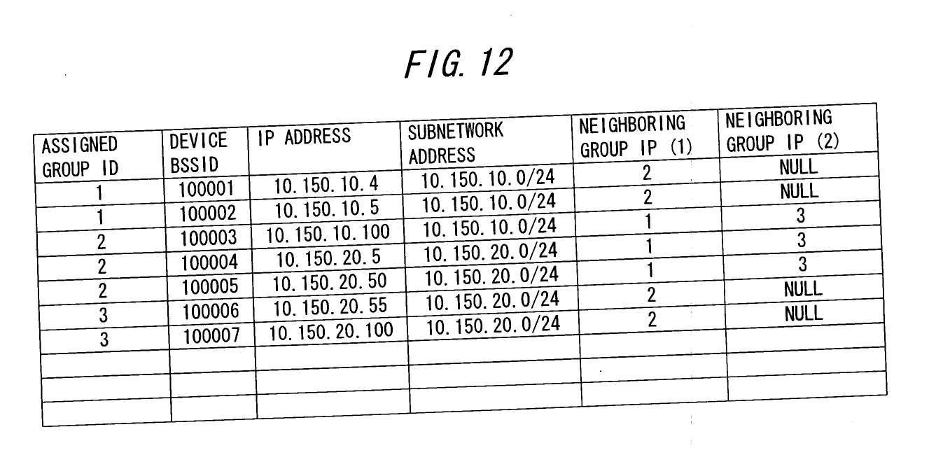

The neighboring group list 213 is stored in the memory etc of the management server 2 and is registered with items of information on the connecting configuration between the respective wireless transmission devices within the mobile communication system. The neighboring group list 213 may be preset by, e.g., a system administrator or a system maintenance technician employing an input/output terminal (unillustrated) etc. This neighboring group list 213 will hereinafter be described with reference to FIG. 12. FIG. 12 is a diagram showing the neighboring group list.

The neighboring group list 213 retains an assigned group ID, a device BSSID, an IP address, a subnetwork address, a neighboring group ID (1) and a neighboring group ID (2), etc.

Set in the assigned group ID field is an ID for identifying each of groups into which the respective wireless transmission devices in the mobile communication system are grouped corresponding to connecting environments thereof. For instance, a group of the neighboring wireless transmission devices is grouped to belong to one group in a predetermined range.

Group IDs of the neighboring groups are set on a group-by-group basis respectively in the neighboring group ID fields (1) and (2). In the example in FIG. 12, the neighboring group of the group ID [1] has a group ID [2], and the neighboring groups of the group ID [2] have group IDs [1] and [3].

Note that the device BSSID field, the IP address field and the subnetwork address field have the same contents as those of the respective fields in the neighboring device list explained in the first embodiment.

### Configuration Management Unit

The configuration management unit 212 refers to the neighboring group list 213, thereby generating the respective items of information on the wireless transmission devices neighboring to the individual wireless transmission devices. The configuration management unit 212 distributes the generated information to each of the corresponding wireless transmission devices.

The configuration management unit 212, in the example in FIG. 12, when generating the neighboring device information on the wireless transmission device having the device BSSID [100001], generates a neighboring device list containing the wireless transmission device [100002] belonging to the same group [1] and the wireless transmission devices [100003], [100004] and [100005] each belonging to the neighboring group [2] (the neighboring group ID (1)). Further, when generating a neighboring device list about each of the wireless transmission devices belonging to the group ID [2], the neighboring groups have the group IDs [1] and [3], and hence there is contained the information on all the wireless transmission devices belonging to the groups [1] [2] and [3].

### Operational Example

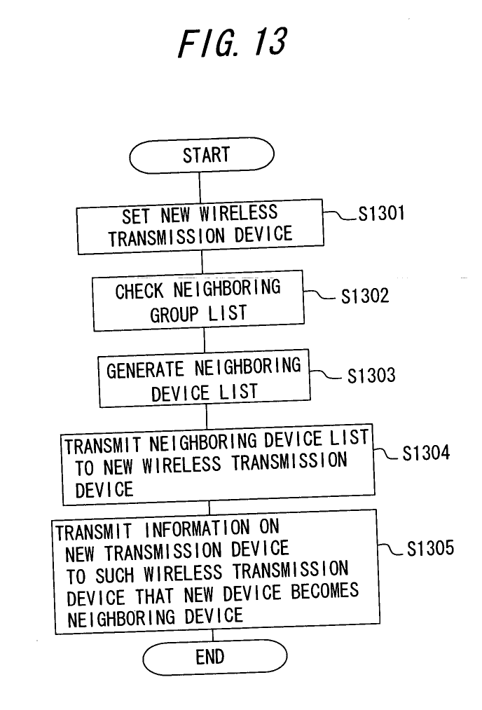

Next, an operational example of the wireless transmission device in the second embodiment will hereinafter be described with reference to FIG. 13. FIG. 13 is a flowchart showing the operational example of the configuration management unit. In the case of installing a new wireless transmission device within the mobile communication system, if the connection configuration in the mobile communication system is changed, the neighboring group list 213 of the management server 2 is updated. FIG. 13 shows the operational example in the case of installing the new wireless transmission device within the system.

When detecting that the wireless transmission device is newly set in the neighboring group list 213 (S1301), the management server 2 checks the neighboring group list 213 (S1302). Then, the management server 2 generates, based on the neighboring group list 213, respectively the information on the neighboring wireless transmission device to each of the wireless transmission devices (S1303).

When generating the information on the neighboring wireless transmission device, the management server 2 transmits the information generated for the newly installed wireless transmission device to this wireless transmission device (S1304). At this time, the management server 2 may transmit these items of information via a message defined as an extended version of the ICMP message, and may also transmit the information in an original message format.

Next, the management server 2 sends the generated information to such a wireless transmission device that the newly installed wireless transmission device should be contained in the neighboring device list (S1305). Note that the management server 2 may also transmit these items of information to all the wireless transmission devices. The wireless transmission device receiving the neighboring device information sent from the management server 2 updates its own neighboring device list 113 based on the neighboring device information.

### Operation/Effect in Second Embodiment

Herein, an operation and an effect of the wireless transmission device in the second embodiment discussed above will be stated.

In the mobile communication system in the second embodiment, the management server 2 for managing batchwise the connecting configuration between the wireless transmission devices within the system is provided, thereby automatically distributing the neighboring device list 113 of each wireless transmission device. In the management server 2, the neighboring group list 213 for managing batchwise the location information about the wireless transmission devices configuring the system is referred to, whereby the neighboring device list 113 of each wireless transmission device is automatically generated. Each wireless transmission device receiving the distribution updates, with this distributed information, the neighboring device list that is referred to for the determination of other wireless transmission devices sharing the DHCP information therebetween.

With this operation, the wireless transmission device in the second embodiment has no necessity of individually managing the neighboring device list, and the neighboring device lists can be managed batchwise on a system basis, thereby making it possible to reduce the operations needed for actualizing the fast handover process.

### Third Embodiment

A mobile communication system configured by the wireless transmission devices in a third embodiment of the present invention will hereinafter be described. In the mobile communication system in the second embodiment discussed earlier, the management server 2 generates and distributes, based on the neighboring group list 213, the neighboring device list 113 to each wireless transmission device.

In the mobile communication system in the third embodiment, each wireless transmission device updates its own DHCP cache table 111 by detecting the radio waves transmitted by the neighboring wireless transmission device. A configuration in the third embodiment, which will hereinafter be described, is an exemplification, and the present invention is not limited to the following configuration.

### System Architecture

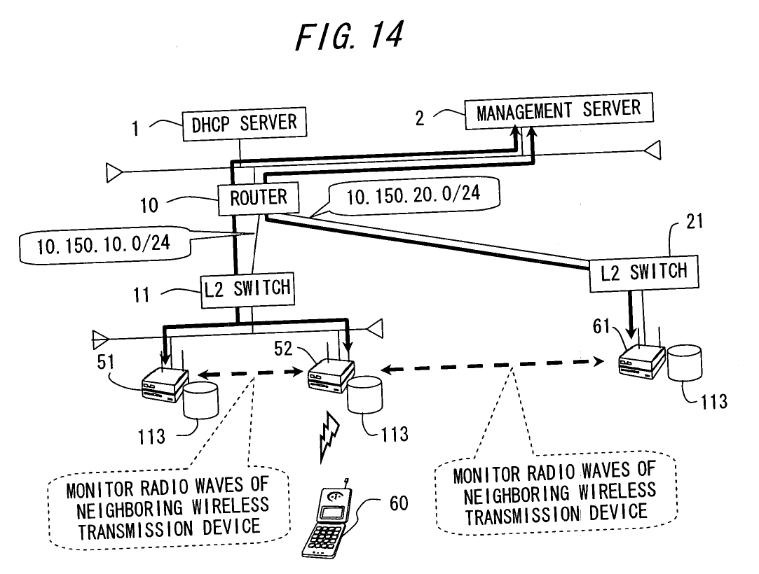

A network configuration of the mobile communication system in the third embodiment will hereinafter be described with reference to FIG. 14. FIG. 14 is a diagram showing the network configuration of the mobile communication system in the third embodiment. The network configuration of the mobile communication system in the third embodiment shall be the same as the network configuration of the mobile communication system in the second embodiment.

### Management Server

The management server 2 in the mobile communication system has the same functional configuration as that in the second embodiment, and further has a function of referring to, when receiving an IP address request designating the device BSSID from the wireless transmission device, the neighboring group list 213 and sending a IP address and a subnetwork address of the device back to this wireless transmission device.

It is to be noted that the neighboring group list 213 managed by the management server 2 may retain only the device BSSID, the IP address and the subnetwork address, and there may be none of the function of generating the information on the neighboring wireless transmission device for each of the wireless transmission devices.

### Wireless Transmission Device

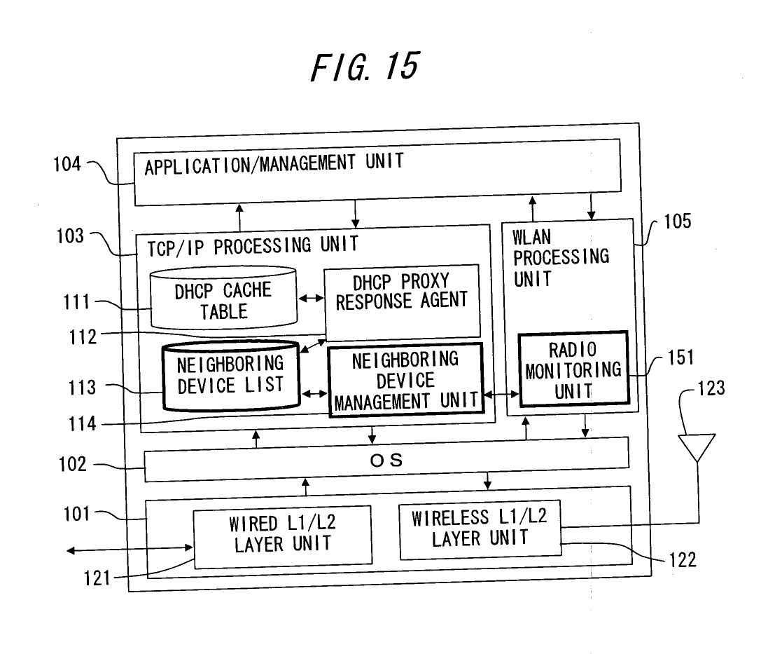

The wireless transmission device 51 (the wireless transmission devices 52 and 61 have the same function as the device 51 has) further has, in addition to the functions in the first embodiment, a function of checking the radio waves transmitted by other wireless transmission devices. With this function, the wireless transmission device 51 detects the neighboring wireless transmission device from an intensity of the received radio waves, and updates its own neighboring device list 113. A functional configuration of the wireless transmission device 51 will hereinafter be described with reference to FIG. 15. FIG. 15 is a diagram showing the functional configuration of the wireless transmission device in the third embodiment.

As shown in FIG. 15, the wireless transmission device 51 further includes, in addition to the components in the first embodiment, a neighboring device management unit 114 and a radio monitoring unit 151. Further, a new field is added to the neighboring device list 113. The different function units from those in the first embodiment will hereinafter be explained.

### Radio Monitoring Unit

The radio monitoring unit 151 monitors the radio waves transmitted from other wireless transmission devices. This function will hereinafter be termed a radio scan. The wireless transmission device, as a number of usable channels and usable frequency bandwidths are determined corresponding to a supportable communication system, detects the neighboring wireless transmission device by measuring a signal intensity per channel. For instance, the usable channel number is determined such that 8 channels are set for IEEE802.11a, and 14 channels are set for IEEE802.11b.

The radio monitoring unit 151 scans the radio waves at every predetermined channel, thereby acquiring the BSSID of the wireless transmission device defined as a radio signal transmitter and the signal intensity of the signal. The radio monitoring unit 151 transfers the acquired information to the neighboring device management unit 114.

### Neighboring Device List

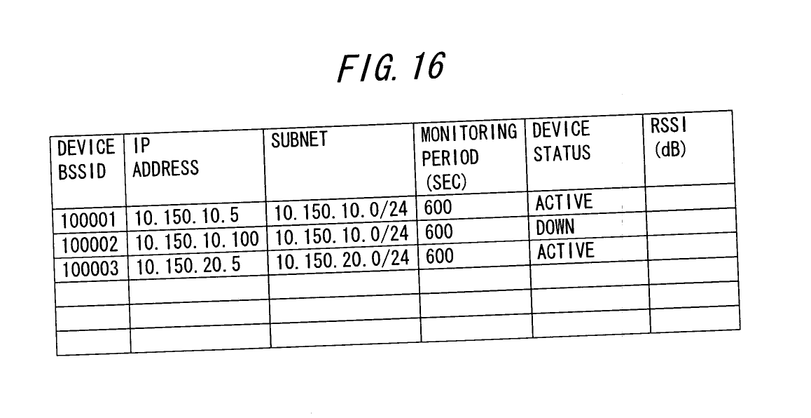

The neighboring device list 113 retains, in addition to the items of information in the first embodiment, further retains RSSI (Received Signal Strength Indicator) information. The signal intensity (decibel (dB)) of the signal transmitted by the wireless transmission device is set (entered) in the RSSI field. FIG. 16 is a diagram showing the neighboring device list in the third embodiment.

### Neighboring Device Management Unit2

The neighboring device management unit 114 updates the neighboring device list 113 on the basis of the BSSID and the signal intensity transferred from the radio monitoring unit 151. The neighboring device management unit 114, when a new wireless transmission device not entered in the neighboring device list 113 is detected by the radio scan, adds this detected wireless transmission device to the neighboring device list 113. At this time, the neighboring device management unit 114 designates the BSSID of the detected wireless transmission device and sends an information request message requesting an IP address, a subnetwork address, etc to the management server 2.

Further, the neighboring device management unit 114, if the acquired signal intensity of the wireless transmission device existing in the neighboring device list 113 is lower than a predetermined value, or if unable to receive the signal transmitted from this wireless transmission device by the signal scan, deletes the information on this wireless transmission device from the neighboring device list 113. The predetermined value for judging this signal intensity may also be preset as a parameter in the memory of the device.

### Operational Example

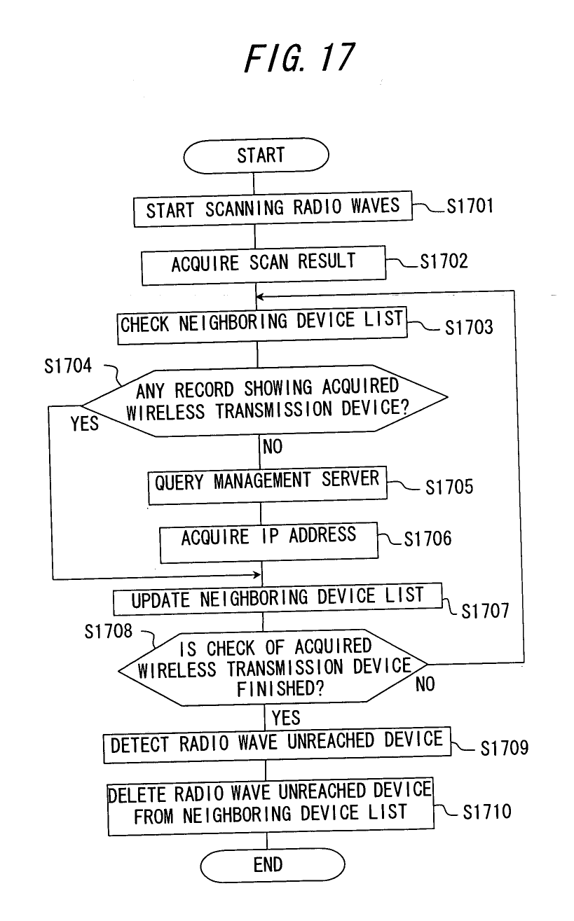

Next, an operational example of the wireless transmission device in the third embodiment will hereinafter be described with reference to FIG. 17. FIG. 17 is a flowchart showing the operational example of the neighboring device management unit.

The radio monitoring unit 151 performs the radio scan about the predetermined channel on the basis of the wireless communication system. (S1701). The radio scan by the radio monitoring unit 151 may be operated at all times and may also be operated with a predetermined period. The radio monitoring unit 151, if corresponding to, e.g., IEEE802.11g, executes the radio scan over the first channel through the fourteenth channel.

The radio monitoring unit 151, when detecting the radio wave having the predetermined intensity as a result of the radio scan, retains the BSSID specifying the wireless transmission device as the radio wave transmitter and the signal intensity thereof. The radio monitoring unit 151, when detecting a plurality of wireless transmission devices as a result of performing the radio scan with respect to all the channels, retains the BSSIDs about the wireless transmission devices and the signal intensities thereof, respectively. The radio monitoring unit 151, upon completion of the radio scan about all the channels, transfers the retained information to the neighboring device management unit 114 (S1702).

The neighboring device management unit 114, when receiving these items of information from the radio monitoring unit 151, checks the neighboring device list 113 (S1703). The neighboring device management unit 114, when confirming that the neighboring device list 113 has an existence of the record containing the setting of the BSSID transferred from the radio monitoring unit 151 (S1704; YES) reflects the signal intensity (RSSI) in this record (S1707).

The neighboring device management unit 114, when confirming that the neighboring device list 113 has no existence of the record containing the setting of the BSSID transferred from the radio monitoring unit 151 (S1704; NO), requests the management server 2 for the IP address by designating this BSSID (S1705). The management server 2 receiving this request message sends, based on the neighboring group list 213, the IP address, the subnetwork address, etc associated with the designated BSSID back to the sender wireless transmission device. The neighboring device management unit 114, when acquiring the IP address etc (S1706), updates the neighboring device list 113 with the acquired information (S1707).

The neighboring device management unit 114, when receiving the information on the plurality of wireless transmission devices from the radio monitoring unit 151, executes the processes (S1703 through S1707) with respect to all items of information (S1708; NO).

Upon completion of the processes about all items of information (S708; YES), the neighboring device management unit 114 detects the wireless transmission device retained in the neighboring device list 113 but not detected by the radio scan (S1709). The neighboring device management unit 114 may deem that there is no detection of any wireless transmission device with no value set in the RSSID field in the neighboring device list 113 or having the setting of an RSSID value less than a predetermined value. The neighboring device management unit 114 deletes the information on the detected wireless transmission device from the neighboring device list 113 (S1710).

### Operation/Effect in Third Embodiment

Herein, an operation and an effect of the wireless transmission device in the third embodiment discussed above will be stated.

In the wireless transmission device in the third embodiment, the intensity of the radio wave at every channel based on the wireless communication system supported in the wireless transmission device, is respectively measured. The wireless transmission device, as the wireless transmission device transmitting the strong radio waves is located in the vicinity of, automatically updates the neighboring device list.

With this operation, according to the wireless transmission device in the third embodiment, the wireless transmission device itself automatically detects other wireless transmission devices located in the vicinity thereof, thereby enabling the automatic management of the neighboring device list, further the actual installing state to be grasped because of the wireless transmission device's detecting other wireless transmission devices by the radio waves, and the neighboring device list to be generated from the assured information.

It is therefore feasible to reduce the operations required for actualizing the fast handover process.

### Fourth Embodiment

A mobile communication system configured by the wireless transmission devices in a fourth embodiment of the present invention will hereinafter be described. In the mobile communication system in the first embodiment discussed earlier, whether there is the DHCP proxy response is made or not is judged corresponding to the received DHCP message and the setting state in the DHCP cache table in the wireless transmission device.

In the mobile communication system in the fourth embodiment, each wireless transmission device grasps a communication application type of the mobile terminal that continues the communication session, and judges whether the DHCP proxy response is made or not by further considering the communication application type. A configuration in the fourth embodiment, which will hereinafter be described, is an exemplification, and the present invention is not limited to the following configuration.

### System Architecture

A network configuration of the mobile communication system in the fourth embodiment shall be the same as the network configuration of the mobile communication system in the first embodiment.

### Wireless Transmission Device

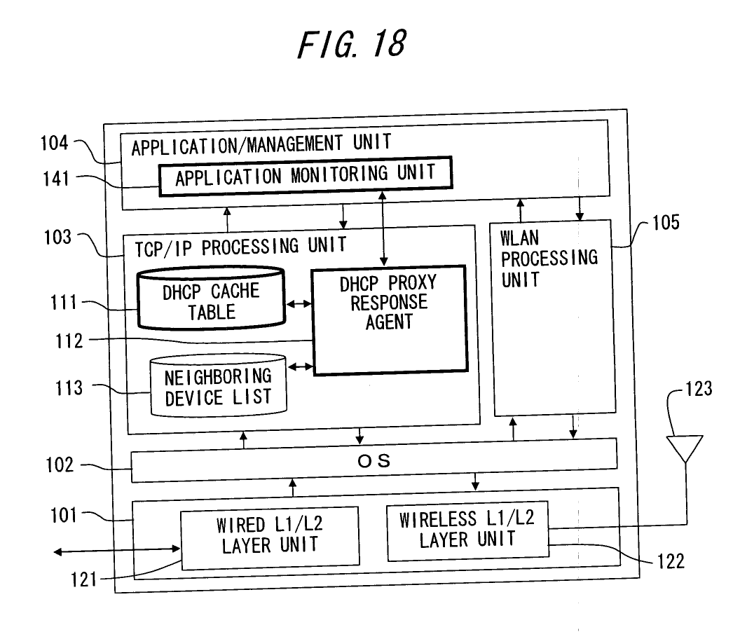

The wireless transmission device 51 (the wireless transmission devices 52 and 61 have the same function as the device 51 has) further has, in addition to the functions in the first embodiment, a function for grasping the communication application type in the continuation of the communication session of the mobile terminal performing the communications via the self-device. The wireless transmission device 51 makes further consideration of this communication application type on the occasion of judging whether the DHCP proxy response is made or not. A functional configuration of the wireless transmission device 51 will hereinafter be explained with reference to FIG. 18. FIG. 18 is a diagram showing the functional configuration of the wireless transmission device in the fourth embodiment.

As illustrated in FIG. 18, the wireless transmission device 51 further has an application monitoring unit 141 in addition to those in the first embodiment. Further, a new field is added to the DHCP cache table 111. The different function units from those in the first embodiment will hereinafter be explained.

### Application Monitoring Unit

The application monitoring unit 141 manages the communication session of the mobile terminal performing the communications via the self-device, and acquires the communication application type of the application actualized by the communication session. The communication application type is exemplified such as SIP (Session Initiation Protocol), H.323, HTTP (HyperText Transfer Protocol) and SMTP (Simple Mail Transfer Protocol). The application monitoring unit 141 acquires the application type of a communication message from a port number etc contained in the IP packet forwarded, and transfers this application type together with the information for specifying the mobile terminal as a message sender to the agent 112.

### DHCP Proxy Response Agent

The agent 112 sets the application type transferred from the application monitoring unit 141 in an application type field in the DHCP cache table 111.

The agent 112, when receiving the DHCP-DISCOVER message, refers to the DHCP cache table 111. The agent 112 judges that the DHCP proxy response should be made if the DHCP cache table 111 has an existence of the record associated with the sender mobile terminal, if the on-site flag in this record is cleared and if the application type in a realtime system is set in the application type field. The application type in the realtime system includes, for instance, a communication application in which the service is interrupted when the communication session as defined by SIP and H.323 is disconnected, and the application other than the realtime system includes, for example, a communication application in which even when the communication session as defined by HTTP and SMTP is disconnected, this does not affect the service.

The agent 112 advertises (DHCP information advertisement) the DHCP information retained in the DHCP cache table 111 to the wireless transmission devices registered in the neighboring device list 113 and each having the record, in the DHCP cache table 111, of which the application type field has the setting (entry) of the application type in the realtime system.

### DHCP Cache Table 111

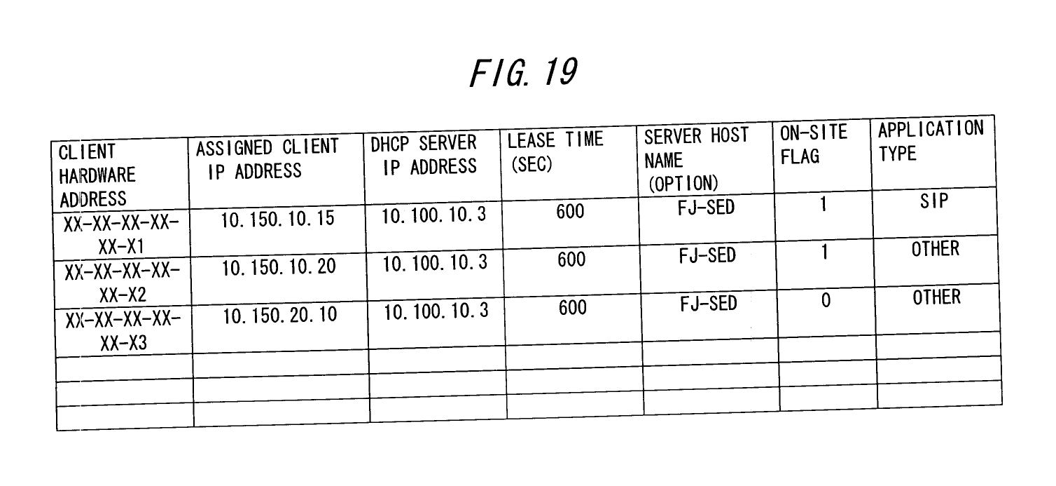

The DHCP cache table 111 further includes the application type field. This application type field is registered with such a communication application type that the mobile terminal specified by the record continues the communication session. FIG. 19 is a diagram showing the DHCP cache table 111 in the fourth embodiment. In the example in FIG. 19, the application type field is registered with ID information specifying the communication application type with respect to the application in the realtime system and is registered with ID information [OTHER] representing the applications other than those in the realtime system.

### Operation/Effect in Fourth Embodiment

Herein, an operation and an effect of the wireless transmission device in the fourth embodiment discussed above will be stated.

In the wireless transmission device in the fourth embodiment, the communication application type in the continuation of the communication session on the mobile terminal defined as a message sender, is acquired from a message sent from the mobile terminal and is set in the application type field in the related record in the DHCP cache table 111.

The wireless transmission device, when receiving the DHCP-DISCOVER message, in addition to the judgment in the first embodiment, judges whether the DHCP proxy response should be made or not by referring to this application type field. At this time, the wireless transmission device makes the DHCP proxy response only in such a case that the acquired communication application type specifies the communication application having a possibility of affecting the communication service due to the disconnection of the communication session.

Further, the wireless transmission device does not give the DHCP information advertisement to other wireless transmission devices with respect to the record related to the mobile terminal, wherein the communication application type having the possibility of affecting the communication service due to the disconnection of the communication session, is set in this application type field.

With this scheme, in the wireless transmission device in the fourth embodiment, only the information about the mobile terminal executing the specified communication application is shared among the wireless transmission devices, and there is made none of the proxy response to the message concerning the IP address assignment, which is sent from the mobile terminal executing the communication application other than the specified communication application.

This scheme, according to the present invention, enables the proxy response that narrows down the communications services because of making it possible to make the proxy response to only the mobile terminal executing the communications having the possibility of affecting the communication service due to the disconnection of the communication session.

### Modified Example of Fourth Embodiment

Each of the wireless transmission devices configuring the mobile communication system in the fourth embodiment discussed above acquires the communication application type in the continuation of the communication session, and determines whether or not the DHCP proxy response is made corresponding to the communication application type, however, there may also be conducted control to monitor a status of the communication application and to release the already-acquired IP address when this communication application terminates.

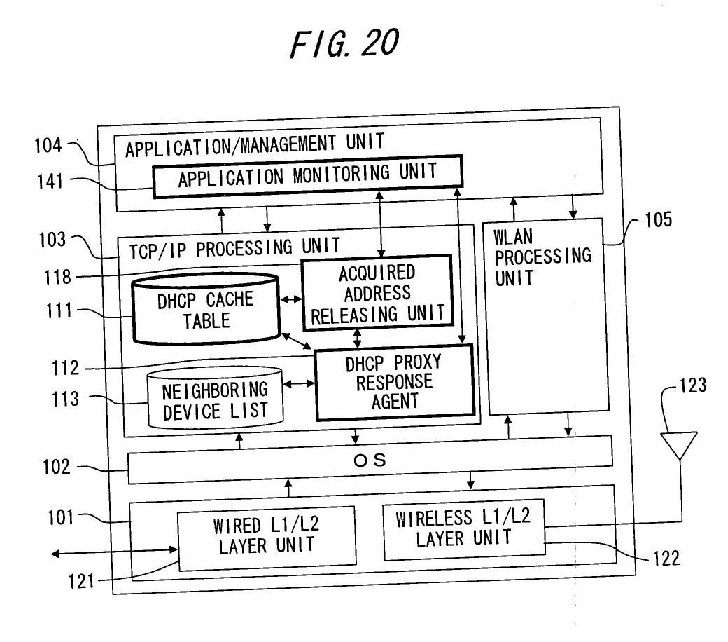

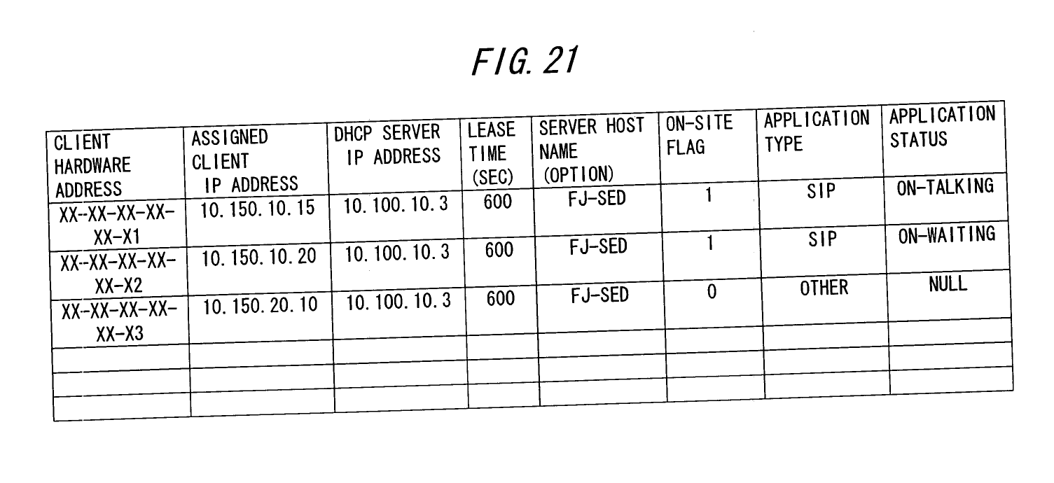

A functional configuration of the wireless transmission device in the modified example will hereinafter be described with reference to FIGS. 20 and 21. FIG. 20 is a diagram showing the functional configuration of the wireless transmission device in the modified example of the fourth embodiment. FIG. 21 is a diagram showing the DHCP cache table in the modified example of the fourth embodiment. The wireless transmission device 51, as shown in FIG. 20, further includes an acquired address releasing unit 118 as an addition to those in the fourth embodiment. Further, a new field is added to the DHCP cache table 111. The different function unit from the fourth embodiment will hereinafter be explained.

### DHCP Proxy Response Agent

The agent 112 sets the application type transferred from the application monitoring unit 141 in the application type field in the DHCP cache table 111, and, if this communication application type is the application in the realtime system, further sets a status of this application in the DHCP cache table 111.

### DHCP Cache Table

The DHCP cache table 111 further includes the application status field. Status information of the communication application executed by the mobile terminal specified by the related record, is set (entered) in this application status field. FIG. 21 is a diagram showing the DHCP cache table in the modified example of the fourth embodiment. In the example in FIG. 21, with respect to SIP, the communication application statuses such as [on-talking] and [on-waiting] are registered. It is to be noted that the should-be-retained status information of the communication application is not limited to the example in FIG. 21 if able to judge such a status that the IP address should be released.

### Acquired Address Releasing Unit

The acquired address releasing unit 118 monitors the application status field in the DHCP cache table 111. The acquired address releasing unit 118, when detecting that the application status field changes to a termination status, controls the agent 112 to execute an IP address releasing process for releasing the IP address acquired by the mobile terminal specified by the related record.

This IP address releasing process is a process of discarding, when the wireless transmission device 51 receives the DHCP-REQUEST message sent from the mobile terminal in order to update the lease time of the IP address, this message without being transferred to the DHCP server 1. With this process, the mobile terminal is unable to receive the DHCP-ACK message serving as a response to the DHCP-REQUEST message, therefore recognizes the necessity of releasing the present IP address, then judges that the IP address acquisition request should be sent again, and sends the DHCP-DISCOVER message.

The acquired address releasing unit 118, in this IP address releasing process, may control the agent 112 and may delete the related record from the DHCP cache table 111. Further, the acquired address releasing unit 118, after deleting the related record, may advertise the DHCP information in the latest DHCP cache table 111.

### Operational Example

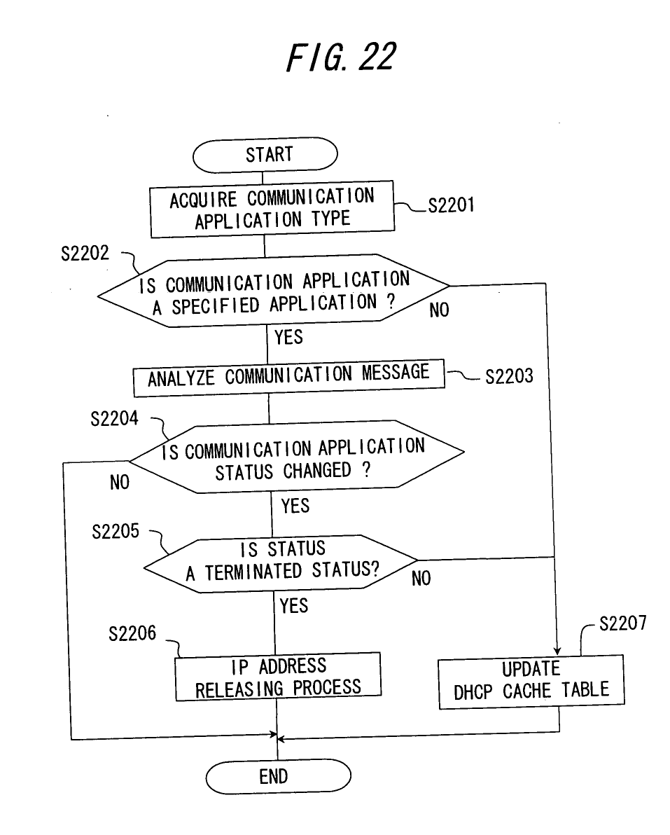

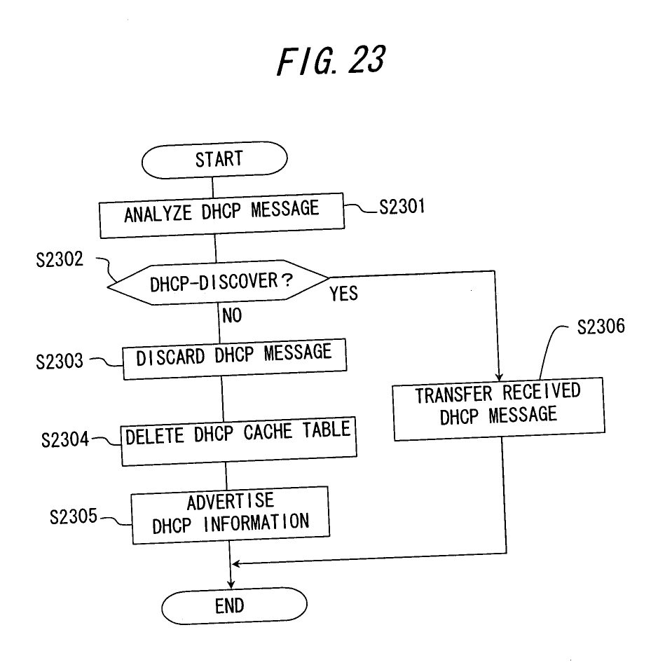

Next, an operational example of the wireless transmission device in the modified example of the fourth embodiment will hereinafter be described with reference to FIGS. 22 and 23. FIG. 22 is a flowchart showing the operational example of the wireless transmission device in the modified example of the fourth embodiment. FIG. 23 is a flowchart showing the IP address releasing process in the modified example of the fourth embodiment.

The application monitoring unit 141 acquires the application type of the communication message from a port number etc contained in the IP packet forwarded (S2201), and transfers this application type together with the information specifying the sender mobile terminal to the agent 112.

The agent 112 sets the application type transferred from the application monitoring unit 141 in the application type field in the DHCP cache table 111, and judges whether or not this communication application type is the application in the realtime system (S2202). This judgment may also be done by comparing the pre-retained information on the application type in the realtime system with the application type transferred from the application monitoring unit 141.

The agent 112, when judging that the transferred application type is the application in the realtime system (S2202; YES), makes a message analysis of the IP packet to be further forwarded (S2203). The agent 112, through this message analysis, reads the status information of the communication application contained in the IP packet, and sets this status information in the application status field in the DHCP cache table 111.

While on the other hand, the agent 112, when judging that the application type transferred from the application monitoring unit 141 is an application other than the application in the realtime system (S2202; NO), sets this application type in the application type field in the DHCP cache table 111 (S2207), and terminates the processing.

The acquired address releasing unit 118, when detecting that the status information set in the application status field in the DHCP cache table 111 changes to the termination status (S2204; YES, S2205; YES), controls the agent 112 to execute the IP address releasing process for releasing the IP address acquired by the mobile terminal specified by the related record (S2206).

On the other hand, the acquired address releasing unit 118, if there is no change in the status information set in the application status field in the DHCP cache table 111 (S2204; NO), comes to an end without executing any process. Further, the acquired address releasing unit 118, when judging, though there is the change in the status information set in the application status field in the DHCP cache table 111 (S2204; YES), that this status information does not indicate the termination status (S2205; NO), sets this status information in the application status field in the DHCP cache table 111 (S2207), and terminates the processing.

When the IP address releasing process is executed, the agent 112, upon detecting the DHCP message sent from the target mobile terminal, executes a processing flow shown in FIG. 23 in place of the processing flow illustrated in FIG. 8. Note that the processing flow shown in FIG. 8 is executed for the DHCP message from the mobile terminal, about which the IP address releasing process should not be executed.

In the processing flow shown in FIG. 23, the agent 112 analyzes the DHCP message (S2301) and judges whether or not this message is the DHCP-DISCOVER message (S2302). The agent 112, when judging the message is not the DHCP-DISCOVER message (S2302; NO), discards the received DHCP message (S2303). Namely, the agent 112 does not forward the received DHCP message to the DHCP server 1. Herein, the judgment as to whether the message is the DHCP-DISCOVER message or not, basically aims at discarding the DHCP-REQUEST message and also intends to discard the DHCP-ACK message etc other than the DHCP-REQUEST message because of having already no necessity. Note that the DHCP-DISCOVER message becomes a new IP address setting request and is therefore forwarded to the DHCP server 1 without being discarded (S2306).

The acquired address releasing unit 118, in this IP address releasing process, controls the agent 112 and deletes the related record from the DHCP cache table 111 (S2304). In this case, the acquired address releasing unit 118, after deleting the related record, advertises the DHCP information in the latest DHCP cache table 111 (S2305).

### Operation/Effect in Modified Example of Fourth Embodiment

Herein, an operation and an effect of the wireless transmission device in the modified example of the fourth embodiment discussed above will hereinafter be stated.

In the wireless transmission device in the modified example, the status of the communication application is acquired together with the communication application type in the continuation of the communication session from the message sent by the mobile terminal and is retained in the DHCP cache table 111. Thereafter, in the wireless transmission device, when receiving the DHCP-REQUEST message, the application status field is checked together with the application type field in the DHCP-cache table 111.

With this operation, in the wireless transmission device, if the communication application having the possibility of affecting the communication service due to the disconnection of the communication session comes to the termination status, the DHCP-REQUEST message requesting the continuous usage of the IP address transmitted from the mobile terminal is discarded without being transferred to the server. As a result, in the mobile terminal, it is judged that the IP address can not be continuously used, and the DHCP-DISCOVER message is resent. With this operation, it follows that the IP address corresponding to the subnetwork to which the handover destination wireless transmission device is connected, is newly assigned.

Hence, according to the present invention, it is possible to eliminate the establishment of the unnecessary IP tunnel and the transfer of the DHCP message to the server via the IP tunnel. Namely, there is made the proxy response with respect to only the DHCP message sent from the mobile terminal that continues the communication application having the possibility of affecting the communication service due to the disconnection of the communication session comes to the termination status, and it is therefore feasible to actualize the fast handover process in a way that narrows down the communication services.

### Others

The disclosures of Japanese patent application No. JP2005-375451, filed on Dec. 27, 2005 including the specification, drawings and abstract are incorporated herein by reference.

What is claimed is:

1. A wireless transmission device connected to any one of a plurality of subnetworks configuring an IP network including a server managing IP addresses, and connecting a mobile terminal through wireless communications to any one of the plurality of subnetworks, comprising:
an address storage unit storing, when mutually transferring a message related to assignment of an IP address between the mobile terminal and the server, identifying information specifying the mobile terminal as a message sender and the IP address assigned to the mobile terminal from the server;
a notifying unit notifying other wireless transmission devices connected to the IP network of the information stored in the address storage unit; and
a proxy response unit responding, as a proxy for the server, when receiving the message sent by the mobile terminal after performing handover from one other wireless transmission device connected to the different subnetwork, a message containing the IP address, as an assigned IP address, already assigned to the mobile terminal that is the sender of the received message based on the information stored in the address storage unit.

2. A wireless transmission device according to claim 1, further comprising:
a device list storage unit storing list information of other wireless transmission devices connected to the IP network and located in the vicinity of the self-device; and
a list updating unit updating the list information based on device information transmitted from a location information server connected to the IP network and managing the location information on the plurality of wireless transmission devices,
wherein the notifying unit determines the wireless transmission device that needs notifying of the information stored in the address storage unit based on the list information.

3. A wireless transmission device according to claim 2, further comprising
a detecting unit detecting radio waves transmitted by other wireless transmission devices connected to the IP network,
wherein the list updating unit updates list information in a way that sets the wireless transmission devices transmitting the detected radio waves, as the other wireless transmission devices located in the vicinity of the self-device, corresponding to intensity of the radio waves detected by the detecting unit.

4. A wireless transmission device according to claim 1, further comprising
an application type acquiring unit acquiring a communication application type in the continuation of a communication session on the mobile terminal that is the message sender from the message sent by the mobile terminal,
wherein the notifying unit notifies of only the information on the mobile terminal of which the acquired communication application type is the specified communication application in items of information stored in the address storage unit, and
the proxy response unit responding, as a proxy for the server, only about the mobile terminal of which the acquired communication application type is the specified communication application.

5. A wireless transmission device according to claim 4, wherein the application type acquiring unit further acquires a termination status of a communication application indicated by the acquired communication application type, and
the proxy response unit, when the acquired communication application type is the specified communication application and when receiving a message requesting a continuous usage of the assigned IP address in the messages sent by the mobile terminal of which the communication application comes to the termination status, discards the received message requesting the continuous usage of the assigned IP address without transferring this message.

6. A mobile communication system having an IP network configured by a plurality of subnetworks, the mobile communication system including a server managing IP addresses,
a plurality of wireless transmission devices each connected to any one of the plurality of subnetworks and connecting a mobile terminal through wireless communications to the subnetwork to which the self-device is connected, and
an installation information server connected to the IP network,
the installation information server comprising:
a location information management unit managing location information with respect to each of the plurality of wireless transmission devices; and
an information transmitting unit transmitting device information, about other wireless transmission devices neighboring to each of the plurality of wireless transmission devices, to each of the plurality of wireless transmission devices,
the wireless transmission device comprising:
an address storage unit storing, when mutually transferring a message related to assignment of an IP address between the mobile terminal and the server, identifying information specifying the mobile terminal as a sender of the message and the IP address assigned to the mobile terminal from the server;
a device list storage unit storing list information on other wireless transmission devices connected to the IP network and neighboring to the self-device;
a list updating unit updating the list information based on the device information transmitted from the installation information server;
a notifying unit notifying other wireless transmission devices contained in the list information of the information stored in the address storage unit; and
a proxy response unit responding, as a proxy for the server, when receiving the message sent by the mobile terminal after performing handover from one other wireless transmission device connected to the different subnetwork, a message containing the IP address, as an assigned IP address, already assigned to the mobile terminal that is the sender of the received message based on the information stored in the address storage unit.

7. An IP address assigning method to a mobile terminal in a mobile communication system having an IP network configured by a plurality of subnetworks, and including a server managing IP addresses and a plurality of wireless transmission devices each connected to any one of the plurality of subnetworks and connecting a mobile terminal through wireless communications to the subnetwork to which the self-device is connected, the IP address assigning method, as the steps executed by the wireless transmission device, comprising:
a storing step of storing, when mutually transferring a message about assignment of an IP address between the mobile terminal and the server, identifying information specifying the mobile terminal as a sender of the message and the IP address assigned to the mobile terminal from the server;
a step of notifying other wireless transmission devices, connected to the IP network, of the information stored by the storing step; and
a step of responding, as a proxy for the server, when receiving the message sent by the mobile terminal after performing handover from one other wireless transmission device connected to the different subnetwork, a message containing the IP address, as an assigned IP address, already assigned to the mobile terminal that is the sender of the received message based on the information stored by the storing step.
